(19) United States
(12) Patent Application Publication
(10) Pub. No.: US 2025/0136841 A1
(43) Pub. Date: May 1, 2025

(54) BLENDED FURNISH WITH IMPROVED PERFORMANCE AND METHODS OF MAKING AND USING THE SAME

(71) Applicant: ARCLIN USA LLC, Alpharetta, GA (US)

(72) Inventors: Samuel W. Lonberg, Fuquay Varina, NC (US); Matthew E. Tucker, Apex, NC (US); Tiara E. O’Neal, Raleigh, NC (US); Arun Narayan, Duluth, GA (US); Francis Loiseau, Longueuil (CA); Mario Dupuis, Greenfield Park (CA); Iordana Triantafillu, Brossard (CA)

(73) Assignee: ARCLIN USA LLC, Alpharetta, GA (US)

(21) Appl. No.: 18/894,936

(22) Filed: Sep. 24, 2024

Related U.S. Application Data
(63) Continuation-in-part of application No. 18/170,450, filed on Feb. 16, 2023, now Pat. No. 12,122,943.
Application No. 18/170,450 is a continuation-in-part of application No. 17/590,466, filed on Feb. 1, 2022.
(60) Provisional application No. 63/282,514, filed on Nov. 23, 2021.
(60) Provisional application No. 63/145,174, filed on Feb. 3, 2021.

(51) Int. Cl. C09D 197/00; C09D 175/02

(52) U.S. Cl. CPC C09D 197/005; C09D 175/02

(57) ABSTRACT

A blended furnish with improved performance characteristics while reducing environmental impact, when applied to a substrate and methods of making and using blended furnish are provided. A composite product using a blended furnish is also provided.

### CROSS-REFERENCE TO RELATED APPLICATIONS

This application is a continuation-in-part application of U.S. patent application Ser. No. 18/170,450, filed on Feb. 16, 2023, which is a continuation-in-part application of U.S. patent application Ser. No. 17/590,466, filed Feb. 1, 2022, and claims benefit of and priority to U.S. Provisional Application No. 63/145,174 filed on Feb. 3, 2021, and U.S. Provisional Application No. 63/282,514, filed Nov. 23, 2021, all of which are herein incorporated by reference in their entirety.

### FIELD OF THE INVENTION

The present invention relates to a blended furnish with improved performance when applied to a substrate. The present invention relates to a composite product using a blended furnish.

### BACKGROUND OF THE INVENTION

Melamine-Urea-Formaldehyde (MUF) resins have become popular for use as adhesives in particle boards (PB) or medium density fiberboards (MDF), as they have been found to reliably enhance physical properties, such as Internal Bond (IB) strength, Modulus of Rupture (MOR), Modulus of Elasticity (MOE), and water-resistant properties, as measured by Water Absorption (WA) and Thickness Swell (TS), compared to urea-formaldehyde (UF) resins. Urea-formaldehyde resins are well known in the art for the same applications, however, these resins have been found to produce relatively weaker particle boards and medium density fiber boards with poor water-resistant properties as evidenced by the graph in FIG. 10. FIG. 10 shows the difference in Internal Bond Strength between UF resins and MUF resins at equivalent molar ratio of F to U and F to M+U (hereinafter the MR ratio), respectively with increased board groups.

Although MUF resins provide these enhanced features, there is a need for an alternative to melamine which is more environmentally friendly, while maintaining the same resin performance.

WO 2016/057390 (WO ‘390) relates to adhesives containing about 20 wt. % to about 40 wt. % of an aldehyde-based resin, 1 wt. % to about 15 wt. % of a kraft lignin, 0.05 wt. % to about 2 wt. % of a surfactant, and 0.5 wt. % to about 10 wt. % of an alkaline compound, and methods for making and using the same. The adhesives of WO ‘390 may have a viscosity of from about 500 cP to about 5,000 cP, at a temperature of about 25° C.

U.S. Pat. No. 8,252,864 (US ‘864) relates to a curable urea/formaldehyde resin composition and a reconstituted wood product made by combining the curable urea/formaldehyde resin with a particulate lignocellulosic material.

There is still a need to modify amino resins to improve the performance characteristics of the adhesive while reducing environmental impact by consuming byproducts from other industrial processes.

### SUMMARY OF THE INVENTION

In some embodiments, a blended furnish, can include a urea-formaldehyde (UF) resin or a melamine-urea-formaldehyde (MUF) resin; a lignosulfonate, a kraft lignin or a sulfonated lignin; a deep eutectic solvent; an alkaline compound; optionally an additive; and a plurality of substrates, wherein the blended furnish has a buffer capacity of 2-200 mL of 0.1 N HCl by the Acid Titration Value (ATV) Method using 20 grams of blended furnish for a period of time up to 20 days.

In other embodiments, a method for preparing a blended furnish, can include adding a plurality of substrates; mixing a urea-formaldehyde (UF) resin or a melamine-urea-formaldehyde (MUF) resin optionally with an amine and water at a pH of 5-11, preferably 6-10; optionally adding one or more additives; adding a lignosulfonate salt, a kraft lignin or a sulfonated lignin and a deep eutectic solvent; optionally adding one or more additives to form the blended furnish, wherein the blended furnish has a buffer capacity of 2-200 mL of 0.1 N HCl by the Acid Titration Value (ATV) Method using 20 grams of blended furnish for a period of time up to 20 days.

In certain embodiments, a method for preparing a blended furnish, can include adding a plurality of substrates; mixing a urea-formaldehyde (UF) resin or a melamine-urea-formaldehyde (MUF) resin, a lignosulfonate salt, a kraft lignin or a sulfonated lignin and a deep eutectic solvent, optionally with an amine and water at a pH of 5-11, preferably 6-10; optionally adding one or more additives to form the blended furnish, wherein the blended furnish has a buffer capacity of 2-200 mL of 0.1 N HCl by the Acid Titration Value (ATV) Method using 20 grams of blended furnish for a period of time up to 20 days.

In some embodiments, a method for preparing a blended furnish, can include adding a plurality of substrates; mixing a lignosulfonate salt, a kraft lignin or a sulfonated lignin and a deep eutectic solvent with the substrates; adding a urea-formaldehyde (UF) resin or a melamine-urea-formaldehyde (MUF) resin optionally with an amine and water at a pH of 5-11, preferably 6-10; optionally adding one or more additives to form the blended furnish, wherein the blended furnish has a buffer capacity of 2-200 mL of 0.1 N HCl by the Acid Titration Value (ATV) Method using 20 grams of blended furnish for a period of time up to 20 days.

In further embodiments, a composite product, can include a plurality of substrates; and at least partially cured blended furnish, wherein the blended furnish, prior to curing, can include a urea-formaldehyde (UF) resin or a melamine-urea-formaldehyde (MUF) resin; a lignosulfonate, a kraft lignin or a sulfonated lignin; a deep eutectic solvent; an alkaline compound; optionally an additive; and a plurality of substrates, wherein the blended furnish has a buffer capacity of 2-200 mL of 0.1 N HCl by the Acid Titration Value (ATV) Method using 20 grams of blended furnish for a period of time up to 20 days.

In order to satisfy this need, the present disclosure relates to a resin system and methods of making resin system wherein lignosulfonate is added to UF and MUF adhesives. An aspect of the present invention is based on the addition of lignosulfonate to amino resins which improves the performance characteristics of the adhesive while reducing environmental impact by consuming byproducts from other industrial processes.

In a first aspect, the disclosure relates to a resin system comprising:
a urea-formaldehyde (UF) resin or melamine-urea-formaldehyde (MUF), prepared by:
mixing one or more urea compounds, one or more formaldehyde compounds, a buffering and stabilizing agent and optionally one or more melamine compounds to form a mixture, optionally heating while mixing for at least one minute to form a UF resin or MUF resin, wherein the UF resin or MUF resin has a molar ratio (MR) of total moles formaldehyde to total moles urea plus, if present, the one or more melamine compounds of from about 0.25:1 to about 2.50:1, or from about 0.25:1 to about 1.5:1, and
if a pH of the UF resin or MUF resin is not 6.5 to about 10.0, or from about 8.0 to about 10.0, or from about 8.0 to about 9.0 then one or more alkaline compounds or acidic compounds are mixed with the UF resin or MUF resin until the pH is 6.5 to about 10.0, or from about 8.0 to about 10.0, or from about 8.0 to about 9.0 to form the resin system,
wherein one or more lignosulfonate compounds are added to the mixture or are added to the formed UF resin or MUF resin in an amount of from about 0.1 wt. % to about 30 wt. %, or from about 1.0 wt. % to about 20 wt. %, or from about 1.0 wt. % to about 10 wt. %, based on a total weight of the resin system,
about 0.0 wt. % to about 40 wt. % of water, based on the total weight of the resin system, and
wherein the resin system has a buffer capacity of 2 to 400 mL, or greater than 5 to 150 mL, preferably 20 to 60 mL of 0.1 N HCl by the ATV Method for a period of time of at least about 20 days at 25° C.

In the foregoing embodiment, the urea-formaldehyde (UF) resin or melamineurea-formaldehyde (MUF), may be prepared by:
mixing a first set of components comprising one or more urea compounds and one or more formaldehyde compounds and optionally one or more melamine compounds, optionally heating while mixing for at least one minute to form a first reaction product having an initial molar ratio (IMR) of total moles of the one or more formaldehyde compounds to moles of the one or more urea compounds plus, if present, the one or more melamine compounds of from about 0.7:1 to 7:1, or about 1:1 to 5:1, or 1.4:1 to 4.5:1 up to the end of condensation,
mixing the first reaction product with a second set of components comprising one or more urea compounds and a buffering and stabilizing agent and optionally one or more melamine compounds, optionally heating while mixing to form the UF resin or MUF resin, wherein the UF resin or MUF resin may have a molar ratio (MR) of total moles formaldehyde to total moles urea plus, if present, the one or more melamine compounds of from about 0.25:1 to about 2.50:1, or from about 0.25:1 to about 1.5:1, and
if a pH of the UF resin or MUF resin is not 6.5 to about 10.0, or from about 8.0 to about 10.0, or from about 8.0 to about 9.0 then one or more alkaline compounds or acidic compounds may be mixed with the UF resin or MUF resin until the pH is 6.5 to about 10.0, or from about 8.0 to about 10.0, or from about 8.0 to about 9.0 to form the resin system,
wherein one or more lignosulfonate compounds may be included with the first set of components and/or with the second set of components and/or after the formation of the UF resin or MUF resin in an amount of from about 0.1 wt. % to about 30 wt. %, or from about 1.0 wt. % to about 20 wt. %, or from about 1.0 wt. % to about 10 wt. %, based on a total weight of the resin system,
about 0.0 wt. % to about 40 wt. % of water, based on the total weight of the resin system, and
wherein the resin system may have a buffer capacity of 2 to 400 mL, or greater than 5 to 150 mL, preferably 20 to 60 mL of 0.1 N HCl by the ATV Method for a period of time of at least about 20 days at 25° C. This second step of mixing the first reaction product with a second set of components comprising one or more urea compounds and a buffering and stabilizing agent can be performed for any number of reasons, one of which may be to tie up any excess formaldehyde left over from the first step. The inventive resin system can be prepared in one step, two steps, three steps or more.

In each of the foregoing embodiment, one or more melamine compounds can be added, or melamine compounds can be excluded, or Kraft lignin can be excluded.

In each of the foregoing embodiments, the one or more melamine compounds can be added in up to a 1:1 molar ratio with the total moles of the one or more urea compounds in the resin system, or the one or more melamine compounds can be added in 0.001:1 to a 0.5:1 molar ratio with the total moles of the one or more urea compounds in the resin system, or the one or more melamine compounds can be added in a 0.01:1 to 0.25:1 molar ratio with the total moles of the one or more urea compounds in the resin system.

In each of the foregoing embodiments, the resin system comprising the one or more lignosulfonate may have a color that is noticeably different than the color of pure UF/MUF resins; or wherein within 72 hours following formation of the resin system, 1 liter of the resin system may have an orange yellow, red, tan or brown color; or wherein within 72 hours following formation of the resin system, the resin system may have a color which is in the range of 4 to 40+using the official AIH SRM (Standard Research Method) Number Scale for the color of beer. Alternatively, the resin system is in a range of 19 to 36, or 20 to 35 using the official AIH SRM (Standard Research Method) Number Scale.

In each of the foregoing embodiments, the resin system may include
about 5 wt. % to about 40 wt. %, or from about 10 wt. % to about 35 wt. %, or from
about 15 wt. % to about 30 wt. % of the one or more formaldehyde compounds,
about 5 wt. % to about 35 wt. %, or from about 10 wt. % to about 30 wt. % or from
about 15 wt. % to about 25 wt. % of the one or more urea compounds in the first set of components,
about 5 wt. % to about 50 wt. %, or from about 10 wt. % to about 45 wt. %, or from
about 15 wt. % to about 40 wt. % of the one or more urea compounds in the second set of components,
about 0.1 wt. % to about 30 wt. %, or about 0.1 wt. % to about 25 wt. %, or about 0.1 wt. % to about 20 wt. %, or about 1.0 wt. % to about 15 wt. %, or about 2.0 wt. % to
about 5.0 wt. %, or more than 2.0 wt. % to about 5.0 wt. % of the lignosulfonate,
about 0.0 wt. % to about 40 wt. % of water, and
wherein each weight percent is based on the total weight of the resin system.

In each of the foregoing embodiments, the pH of the resin system, which is from greater than 6.5 to about 10.0, or from about 8.0 to about 9.0, can be due to the effect from the buffering and stabilizing agent and there is no need to add one or more alkaline compounds or acidic compounds. In each of the foregoing embodiments, the resin system may include the melamine in an amount of from about 0.0 wt. % to about 30 wt. % or from about 0.0 wt. % to about 25 wt. %, or from about 0.0 wt. % to about 20 wt. % or from about 0.1 wt. % to about 15 wt. %, based on the total weight of the resin system. In some embodiments, no melamine is added to the resin composition.

In each of the foregoing embodiments, the lignin species may be selected from calcium lignosulfonate, magnesium lignosulfonate, ammonium lignosulfonate, or sodium lignosulfonate, preferably ammonium lignosulfonate or sodium lignosulfonate.

In each of the foregoing embodiments, the UF or MUF resin, excluding the lignin species, may have a number average molecular weight (Mn) of from about 300 daltons to about 20,000 daltons, or from about 1,000 daltons to about 10,000 daltons, or from about 1,500 daltons to about 9,000 daltons, or from about 2,000 daltons to about 5,000 daltons; the weight average molecular weight (Mw) is about 1,000 to about 400,000, or from about 30,000 to about 200,000 daltons, as measured by gel permeation chromatography; and the polydispersity (Mw/Mn) is about 10-100.

In each of the foregoing embodiments, the alkaline compound may be selected from a Group I or II metal hydroxide, preferably the alkaline compound is sodium hydroxide, potassium hydroxide, ammonium hydroxide, or any mixture thereof.

In each of the foregoing embodiments, the resin system is stable and may have a kinematic viscosity of about 100 to about 1,500 cSt, or about 100 to about 1,000 cSt, or about 100 to about 600 cSt at a temperature of about 25° C., as measured by the Gardner-Holdt viscosity method, for a period of time of at least about 20 days at 25° C., and wherein the period of time starts when the resin system is initially produced, and the resin system may have a fast cure rate so to achieve an improvement in internal bond strength when compared to the Control resin system of up to 20%, preferably 10% to 20% at <7.0 press factor at 350° F. platen temperature. When measured at full cure at <7.0 press factor at 350° F. platen temperature, the IB is at least as good for the inventive resin as compared to the comparative resin. The control resin is a UF resin of Comparative Example B, below.

In a second aspect, the disclosure relates to an adhesive, including the resin system of each of the foregoing embodiments.

In a third aspect, the disclosure relates to a blended furnish, including a plurality of granulated, or fibrous lignocellulose substrates and the adhesive of the foregoing embodiment.

In a fourth aspect, the disclosure relates to a composite lignocellulosic product, including a plurality of lignocellulosic substrates and an at least partially cured resin system, wherein the resin system, prior to curing, including each of the foregoing embodiments of the resin system.

In the foregoing embodiment, the composite product may be a particleboard, a fiberboard, a plywood, an oriented strand board, or a laminated veneer board, medium density fiberboard, more preferably, the composite product is a particle board or medium density fiberboard.

In a fifth aspect, the disclosure relates to a composite comprising: the inventive resin system of each of the foregoing embodiments and a glass mat or abrasives, or the inventive resin system of each of the foregoing embodiments in a glass fiber nonwoven, or the inventive resin system of each of the foregoing embodiments as an impregnation resin in one or more layers of an overlay.

In the foregoing embodiment, the composite may be a glass fiber nonwoven.

In each of the foregoing embodiments, the glass fiber nonwoven may have an average fiber length of 0.75-2.5 inches, preferably 1.0-1.6 inches. The resin system containing the glass fibers can be cured at 200-250° C. for up to a minute. Preferably the resin system containing the glass fibers can be cured at 230° C. for 15 seconds. Also, the average basis weight of the resin in the composite can be 1.4-2.0 lbs/100 ft². Preferably, the average basis weight of the resin in the composite can be 1.5-1.75 lbs/100 ft². In addition, the average loss on ignition can be 15-30%. Preferably, the average loss on ignition can be 18-25%.

In each of the foregoing embodiments, the glass fiber nonwoven which is made from the inventive resin system comprising one or more lignosulfonate compounds may have a dry tensile strength of greater than 10%, preferably greater than 15% to 35%, more preferably greater than 25% to 30% when compared to essentially the same glass fiber nonwoven which is made from the same resin system except without the one or more lignosulfonate compounds. The dry tensile strength of the glass fiber nonwoven products can be tested on a Thwing-Albert tensile tester (150 kg load cell).

In a sixth aspect, the disclosure relates to a method for making a resin system, comprising:
mixing one or more urea compounds, one or more formaldehyde compounds, a buffering and stabilizing agent and optionally one or more melamine compounds to form a mixture, optionally heating while mixing for at least one minute to form a UF resin or MUF resin, wherein the UF resin or MUF resin has a molar ratio (MR) of total moles formaldehyde to total moles urea plus, if present, the one or more melamine compounds of from about 0.25:1 to about 2.50:1, or from about 0.25:1 to about 1.5:1, and if a pH of the UF resin or MUF resin is not 6.5 to about 10.0, or from about 8.0 to about 10.0, or from about 8.0 to about 9.0 then one or more alkaline compounds or acidic compounds are mixed with the UF resin or MUF resin until the pH is 6.5 to about 10.0, or from about 8.0 to about 10.0, or from about 8.0 to about 9.0 to form the resin system,
wherein one or more lignosulfonate compounds are added to the mixture or are added to the formed UF resin or MUF resin in an amount of from about 0.1 wt. % to about 30 wt. %, or from about 1.0 wt. % to about 20 wt. %, or from about 1.0 wt. % to about 10 wt. %, based on a total weight of the resin system,
about 0.0 wt. % to about 40 wt. % of water, based on the total weight of the resin system, and
wherein the resin system has a buffer capacity of 2 to 400 mL, or greater than 5 to 150 mL, preferably 20 to 60 mL of 0.1 N HCl by the ATV Method for a period of time of at least about 20 days at 25° C.

In the foregoing embodiment, the method for making a resin system may comprise:
mixing a first set of components comprising one of more urea compounds, and one or more formaldehyde compounds, and optionally one or more melamine compounds, optionally heating while mixing for at least one minute to form a first reaction product having an initial molar ratio (IMR) of total moles of the one or more formaldehyde compounds to moles of the one or more urea compounds plus, if present, the one or more melamine compounds of from about 1.4:1 to 5:1, or about 1.4:1 to 3:1, or about 2,
mixing the first reaction product with a second set of components comprising one or more urea compounds and a buffering and stabilizing agent and optionally one or more melamine compounds, and optionally heating while mixing to form a UF resin or MUF resin, wherein the UF resin or MUF resin has a molar ratio (MR) of total moles formaldehyde to total moles urea, plus if present, the one or more melamine compounds of from about 0.25:1 to about 2.50:1, or from about 0.25:1 to about 1.5:1, and
if the pH of the UF resin or MUF resin is not 6.5 to about 10.0, or from about 8.0 to about 10.0, or from about 8.0 to about 9.0 then one or more alkaline compounds or acidic compounds may be mixed with the UF resin or MUF resin until the pH of the UF resin or MUF resin is greater than 8.0 or at least 8.4, or is 6.5 to about 10.0, or from about 8.0 to about 10.0, or from about 8.0 to about 9.0 is obtained to form the resin system,
wherein one or more lignosulfonate compound are included with the first set of components and/or with the second set of components in an amount of from about 0.1 wt. % to about 30 wt. %, or from about 1.0 wt. % to about 20 wt. %, or from about 1.0 wt. % to about 10 wt. %, based on a total weight of the resin system,
about 0.0 wt. % to about 40 wt. % of water, based on the total weight of the resin system, and
wherein the resin system has a buffer capacity of 2 to 400 mL, or greater than 5 to 150 mL, preferably 20 to 60 mL of 0.1 N HCl by the ATV Method for a period of time of at least about 20 days at 25° C.

In each of the foregoing embodiments of the method, melamine may be added, melamine may be excluded, or Kraft lignin may be excluded.

In each of the foregoing embodiments of the method, the one or more melamine compounds can be added in up to a 1:1 molar ratio with the total moles of the one or more urea compounds in the resin system, or the one or more melamine compounds can be added in 0.001:1 to a 0.5:1 molar ratio with the total moles of the one or more urea compounds in the resin system, or the one or more melamine compounds can be added in a 0.01:1 to 0.25:1 molar ratio with the total moles of the one or more urea compounds in the resin system.

In each of the foregoing embodiments of the method, the resin system comprising the one or more lignosulfonate may have a color that is noticeably different than the color of pure UF/MUF resins; or wherein within 72 hours following formation of the resin system, 1 liter of the resin system may have an orange yellow, red, tan or brown color; or wherein within 72 hours following formation of the resin system, the resin system may have a color which is in the range of 4 to 40+using the official AIH SRM (Standard Research Method) Number Scale for the color of beer.

In each of the foregoing embodiments of the method, the resin system may include
about 5 wt. % to about 40 wt. %, or from about 10 wt. % to about 35 wt. %, or from
about 15 wt. % to about 30 wt. % of the one or more formaldehyde compounds,
about 5 wt. % to about 35 wt. %, or from about 10 wt. % to about 30 wt. % or from
about 15 wt. % to about 25 wt. % of the one or more urea compounds in the first set of components,
about 5 wt. % to about 50 wt. %, or from about 10 wt. % to about 45 wt. %, or from
about 15 wt. % to about 40 wt. % of the one or more urea compounds in the second set of components,
about 0.1 wt. % to about 30 wt. %, or about 0.1 wt. % to about 25 wt. %, or about 0.1 wt. % to about 20 wt. %, or about 1.0 wt. % to about 15 wt. %, or about 2.0 wt. % to about 5.0 wt. %, or more than 2.0 wt. % to about 5.0 wt. % of the lignosulfonate,
about 0.0 wt. % to about 40 wt. % of water, and
wherein each weight percent is based on the total weight of the resin system.

In each of the foregoing embodiments of the method, the pH of the resin system is from greater than 6.5 to about 10.0, or from about 8.0 to about 9.0 due to the effect from the buffering and stabilizing agent and there is no need to add one or more alkaline compounds or acidic compounds.

In each of the foregoing embodiments of the method, the melamine may be present in an amount of from about 0.0 wt. % to about 30 wt. % or from about 0.0 wt. % to about 25 wt. %, or from about 0.0 wt. % to about 20 wt. % or from about 0.1 wt. % to about 15 wt. %, based on the total weight of the resin system. In some embodiments, no melamine is added to the resin composition.

In each of the foregoing embodiments of the method, the lignin species may be selected from calcium lignosulfonate, magnesium lignosulfonate, ammonium lignosulfonate, or sodium lignosulfonate, preferably ammonium lignosulfonate or sodium lignosulfonate.

In each of the foregoing embodiments of the method, the UF resin or MUF resin, excluding the lignin species, may have a number average molecular weight (Mn) of from about 300 daltons to about 20,000 daltons, or from about 1,000 daltons to 10,000 daltons, or from about 1,500 daltons to about 9,000 daltons, or from about 2,000 daltons to about 5,000 daltons; the weight average molecular weight (Mw) is about 1,000 to about 400,000, or from about 30,000 to about 200,000 daltons; and the polydispersity (Mw/Mn) is about 10-100.

In each of the foregoing embodiments of the method, the alkaline compound may be selected from a Group I or II metal hydroxide, preferably the alkaline compound may be selected from sodium hydroxide, potassium hydroxide, ammonium hydroxide, or any mixture thereof.

In each of the foregoing embodiments of the method, the acidic compound may be selected from chloric acid, hydrobromic acid, hydrochloric acid, hydroiodic acid, nitric acid, perchloric acid, sulfuric acid, sulfurous acid, phosphoric acid, acetic acid, formic acid, benzoic acid, oxalic acid, hydrogen sulfate ion, nitrous acid, hydrofluoric acid, carbonic acid, methanoic acid or any mixtures thereof.

In each of the foregoing embodiments, the resin system is stable and may have a kinematic viscosity of about 100 to about 1500 cSt, or about 100 to about 1,000 cSt, or about 100 to about 600 cSt at a temperature of about 25° C., as measured by the Gardner-Holdt viscosity method, for a period of time of at least about 20 days at 25° C., and wherein the period of time starts when the resin system is initially produced, and the resin system may have a fast cure rate so to achieve an improvement in internal bond strength when compared to the Control resin system of up to 20%, preferably 10% to 20% at <7.0 press factor at 350° F. platen temperature. When measured at full cure at <7.0 press factor at 350° F. platen temperature, the IB is at least as good for the inventive resin as compared to the comparative resin. The control resin is Comparative Example B, discussed below.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1 shows the viscosity stability over time for Comparative Examples A and B and Inventive Examples 1-3 at 25° C.

FIG. 2 shows the viscosity stability over time for Comparative Examples A and B and Inventive Examples 1-3 at 35° C.

FIG. 3 shows the pH decay over time for Comparative Examples A and B and Inventive Examples 1-3 at 25° C.

FIG. 4 shows the Average Internal Bond (IB) Curve over time in seconds for cured resins of Comparative Examples A and B and Inventive Examples 1-3.

FIG. 5 shows the dry out/pre-cure Average Internal Bond of Comparative Examples A and B and Inventive Examples 1-3.

FIG. 6 shows the water tolerance and thickness swell (WATS) of cured resins of Comparative Examples A and B and Inventive Examples 1-3.

FIG. 7 shows the formaldehyde emissions vs. press cycle (90-370 seconds) for Comparative Examples A and B and Inventive Examples 1-3.

FIG. 8 shows the process of producing lignosulfonates.

FIG. 9 shows the differences between lignosulfonates and other lignin species.

FIG. 10 shows a chart (that is not part of the prior art) comparing the measured Internal Bond strength of a resin prepared from urea and formaldehyde (0% melamine) and a resin prepared from melamine, urea, and formaldehyde (2% melamine).

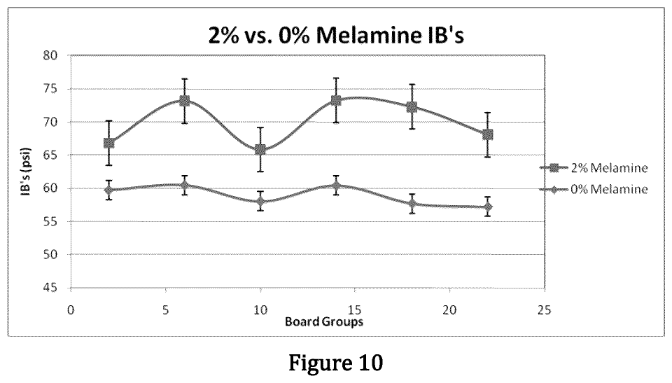

FIG. 11 shows the dry tensile strength of a glass fiber nonwoven of the present invention compared with a glass fiber nonwoven lacking the one or more lignosulfonate compounds.

FIG. 12 demonstrates that the blended furnish comprising the one or more lignosulfonate salt may have a distinct color that is noticeably different from the color of pure UF/MUF resins.

FIG. 13 shows the Average Internal Bond (IB) Curve over time in seconds for cured resins of Comparative Examples A and Inventive Examples 5-9.

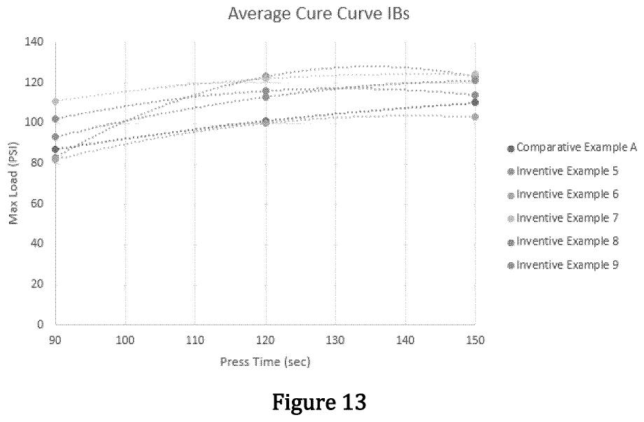

### DETAILED DESCRIPTION OF THE INVENTION

### I. Definitions

The following terms are intended to have the meanings presented therewith below and are useful in understanding the description and intended scope of the present invention.

The articles “a” and “an” may be used herein to refer to one or to more than one (i.e., at least one) of the grammatical objects of the article. By way of example “an analogue” means one analogue or more than one analogue.

The term “about” as used herein, refers that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments. Additionally, in phrase “about X to Y,” is the same as “about X to about Y,” that is the term “about” modifies both “X” and “Y.”

The term “compound” as used herein, refers to salts, complexes, isomers, stereoisomers, diastereoisomers, tautomers, and isotopes of the compound or any combination thereof.

The term “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are used in their inclusive, open-ended, and non-limiting sense.

The term “effective,” as that term is used in the specification and/or claims, means adequate to accomplish a desired, expected, or intended result.

The term “coating” refers to a coating in a form that is suitable for application to a substrate as well as the material after it is applied to the substrate, while it is being applied to the substrate, and both before and after any post-application treatments (such as evaporation, crosslinking, curing, and the like). The components of the coating compositions may vary during these stages.

### II. Blended Furnish

The invention provides a blended furnish compositions and methods.

In some embodiments, a blended furnish, can include a urea-formaldehyde (UF) resin or a melamine-urea-formaldehyde (MUF) resin; a lignosulfonate, a kraft lignin or a sulfonated lignin; a deep eutectic solvent; an alkaline compound; optionally an additive; and a plurality of substrates, wherein the blended furnish has a buffer capacity of 2-200 mL of 0.1 N HCl by the Acid Titration Value (ATV) Method using 20 grams of blended furnish for a period of time up to 20 days.

In certain embodiments, the substrate is selected from the group consisting of lignocellulose substrates, natural fibers substrates, synthetic fibers substrates, glass fibers substrates and mixtures thereof.

In other embodiments, the lignosulfonate is selected from the group consisting of calcium lignosulfonate, magnesium lignosulfonate, potassium lignosulfonate, chrome lignosulfonate, ammonium lignosulfonate, sodium lignosulfonate and mixtures thereof.

In certain embodiments, the lignosulfonate, the kraft lignin or the sulfonated lignin is added to the UF resin or the MUF resin at a resin manufacturer's facility, at a lignosulfonate, kraft lignin or sulfonated lignin supplier's facility, a third party vendor site, in a wood based composite manufacturer's storage tank, in a railcar, truck, or other transportation vehicle or combinations thereof.

In further embodiments, the lignosulfonate, the kraft lignin or the sulfonated lignin is blended with other additives selected from the group consisting of a raw lignin in powder or liquid form, a lignin added to additives combined with additional water, a urea water, a scavenger, a filler, an extender, a wax, a catalyst, a release agent, a buffering agent, a surfactant a cellulose or its derivative, and mixtures thereof.

In certain embodiments, the lignosulfonate, the kraft lignin or the sulfonated lignin is added in the process at a digester (MDF), a blow-line (MDF), a blender (PB), a hi-jet application system (PB/MDF), a refiner (MDF), a mat spray (PB/MDF-end of forming line), a moisture control (blended with water), an extruder, or combinations thereof.

In another embodiment, the lignosulfonate, the kraft lignin or the sulfonated lignin is in solid powder form, liquid form or combinations thereof.

In some embodiments, the alkaline compound comprises ammonia, an amine, a Group I metal hydroxide, a Group II metal hydroxide, Group I metal carbonate, a Group II metal carbonate, or combinations thereof.

In other embodiments, the additive is selected from the group consisting of catalyst, filler, buffer, base, tackifier, wax, water, scavenger, boron compound, phosphate, halogen compound, nitrogen compound, a cellulose or its derivative, and mixtures thereof.

In further embodiments, the cellulose or its derivative is selected from the group consisting of microcrystalline cellulose, nanocellulose, nanofibrillated cellulose, nanocrystalline cellulose, bacterial nanocellulose, viscous cellulose, oxidized cellulose, cellulose ethers, cellulose esters, cellulose fibers, alkyl cellulose, methyl cellulose, methylethyl cellulose, ethyl cellulose, ethyl hydroxyethyl cellulose, hydroxymethyl cellulose, hydroxypropyl cellulose, hydroxypropyl methyl cellulose, hydroxyethyl cellulose, hydroxyethylmethyl cellulose, sodium carboxymethyl cellulose, calcium carboxymethyl cellulose, ethylhydroxyethylcellulose, methylhydroxyethylcellulose, methylhydroxypropyl cellulose, methylhydroxyethylhydroxypropyl cellulose, ethylhydroxyethyl cellulose, ethylhydroxypropyl cellulose, ethylmethylhydroxyethyl cellulose, ethylmethylhydroxypropyl cellulose, hydroxymethylethyl cellulose, hydroxyethylmethyl cellulose, hydroxyethylpropyl cellulose, hydroxypropyl cellulose, hydroxypropylmethyl cellulose, hydroxypropylhydroxyethyl cellulose, carboxymethylhydroxyethyl cellulose, carboxymethylhydroxypropyl cellulose, hydrophobically modified hydroxyethyl cellulose, sulfoethyl cellulose, sulfopropyl cellulose, carboxymethylsulfoethyl cellulose, carboxymethylsulfopropyl cellulose, hydroxyethylsulfoethyl cellulose, hydroxypropylsulfoethyl cellulose, hydroxyethylhydroxypropylsulfoethyl cellulose, methylhydroxyethylsulfoethyl cellulose, methylhydroxypropylsulfoethyl cellulose, methylhydroxyethylhydroxypropylsulfoethyl cellulose, allyl cellulose, allylmethyl cellulose, allylethyl cellulose, carboxymethylallyl cellulose, N,N-dimethylaminoethyl cellulose, N,N-diethylaminoethyl cellulose, N,N-dimethylaminoethylhydroxyethyl cellulose, N,N-dimethylaminoethylhydroxypropyl cellulose, benzyl cellulose, methylbenzyl cellulose, benzylhydroxyethyl cellulose, sodium carboxymethyl cellulose ether and mixtures thereof.

In one embodiment, one or more additives are present.

In another embodiment, the pH of the blended furnish varies from about 3.0 to about 10.0.

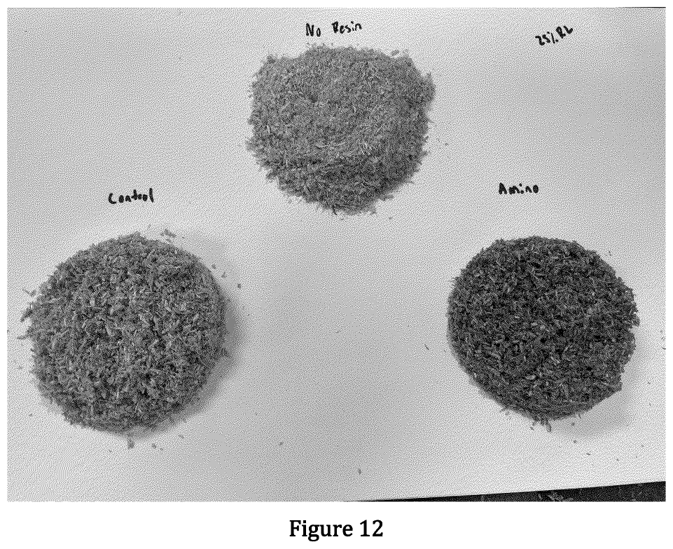

In certain embodiments, the blended furnish can include the one or more lignosulfonate salt may have a distinct color that is noticeably different from the color of pure UF/MUF resins. FIG. 12 demonstrates that the blended furnish comprising the one or more lignosulfonate salt may have a distinct color that is noticeably different from the color of pure UF/MUF resins.

In other embodiments, the lignocellulose substrate can include a granulated lignocellulose substrate, a flake lignocellulose substrate, a fibrous lignocellulose substrate or combinations thereof.

In further embodiments, the blended furnish can include about 0.0 wt. % to about 50 wt. % of the UF resin or the MUF resin; about 0.1 wt. % to about 30 wt. % of the lignosulfonate, the kraft lignin or the sulfonated lignin; about 0.1 wt. % to about 30 wt. % of the deep eutectic solvent; about 0.0 wt. % to about 1 wt. % of the alkaline compound; and about 0.0 wt. % to about 40 wt. % of the additive, wherein each weight percent is based on the total weight of the blended furnish.

In certain embodiments, the lignosulfonate, the kraft lignin or the sulfonated lignin is mixed with a catalyst, a filler, a buffer, a base, a tackifier, wax, water, scavenger, a boron compound, a phosphate, a halogen compound, a nitrogen compound, and mixtures thereof at a resin manufacturer's facility, at a lignosulfonate, kraft lignin or sulfonated lignin supplier's facility, a third party vendor site, in a wood based composite manufacturer's storage tank, in a railcar, truck, or other transportation vehicle or combinations thereof.

In some embodiments, the sulfonated lignin is selected from the group consisting of lignosulfonates: sodium lignosulfonate, calcium lignosulfonate, magnesium lignosulfonate, ammonium lignosulfonate; sulfite lignins; kraft lignins: hardwood: poplar, elm, birch, beech, maple, eucalyptus; softwood: spruces, pinces, firs, hemlocks, cedars, tamarack; agricultural: wheat straw, corn stover, switchgrass, kenaf, bamboo; soda lignins: hardwood: poplar, elm, birch, beech, maple, eucalyptus; softwood: spruces, pinces, firs, hemlocks, cedars, tamarack; agricultural: wheat straw, corn stover, switchgrass, kenaf, bamboo and mixtures thereof.

In another embodiment, the lignosulfonate or the sulfonated lignin is a modified lignosulfonate or a modified sulfonated lignin.

In one embodiment, the lignosulfonate or the sulfonated lignin is modified with a deep eutectic solvent.

In further embodiments, the lignosulfonate or the sulfonated lignin is modified with one or more deep eutectic solvents.

In some embodiments, the process for lignin sulfonation includes in a first step, the preparation of a lignin-containing aqueous suspension with a solids content of up to about 45 wt % and a pH greater than about 6, by mixing at least one lignin with water, optionally in the presence of a base. In the next step, the lignin-containing aqueous suspension can be heated to a temperature of at least about 65° C. and up to about 160° C. under stirring. Then, the lignin is sulfonated by adding a sulfonating agent generating a sulfite ion, a bisulfite ion or a mixture thereof to the heated lignin-containing aqueous suspension. The sulfonation step can be performed under stirring at a sulfonation temperature of at least about 90° C. and up to about 160° C., at a sulfonation pH of from about 6 to about 11. The molar ratio of the sulfonating agent to the lignin can be between about 0.1:1 to about 1.5:1 on a sulfite to monomeric lignin sub-unit basis. After the sulfonation step, the sulfonated lignin-containing mixture can be cooled.

The process can be performed in a vessel or reactor at a pressure between atmospheric pressure and about 100 psi. In some embodiments, the heating step and/or the sulfonation step of the process can be carried out under reflux at atmospheric pressure. Alternatively, some of these steps can be performed in a pressure resistant reactor, wherein the reaction pressure that is observed is primarily that of the theoretical water saturation pressure at the reaction temperature. For example, at 110° C., the reaction pressure can be about 20 psi. At 120° C., the pressure can be about 30 psi. At 150° C., the reaction pressure can be about 70 psi.

The various steps of the process will now be described in more details.

### Preparation of the Lignin-Containing Aqueous Suspension

In one embodiment, the lignin-containing aqueous suspension can be prepared by mixing at least one lignin with water under stirring, in any type of vessel or reactor known in the field, adapted to perform the process at a pressure between atmospheric pressure and about 100psi. While the process will generally be described below mentioning the use of a single type of lignin, the use of two or more types of lignin is also contemplated. In some embodiments, the present process can be performed using any types of lignin, for instance those extracted through Kraft, soda, hydrolysis or solvolysis processes, or using partially or fully modified lignins. Modified lignins that can be used in the process can include reduced, oxidized, graft-modified or alkoxylated lignins, to name a few examples.

In some embodiments, the lignin-containing aqueous suspension can be prepared by mixing a Kraft lignin or soda lignin with water. The use of a mixture of Kraft and soda lignins is also contemplated. Moreover, the process can use more than one Kraft lignin or more than one soda lignin.

A “Kraft” lignin as used in the present process refers to a lignin extracted from the black liquor resulting from the Kraft pulping process. In the Kraft process, sodium hydroxide and sodium sulfide are used in cooking the fibrous plants in pressurized reactors, at temperatures reaching 160-180° C. and at a pH above 12, generating a degraded and solubilized lignin in an aqueous black liquor phase, also containing other components, including carbohydrates and inorganic salts. The black liquor phase is then separated from the solid-containing cellulosic phase (the pulp). Kraft lignin can be precipitated from the black liquor produced in the pulping stage of the Kraft process, prior to or after concentrating the black liquor or prior to its reintroduction in earlier pulping stages or to the feeding of the recovery boiler.

A “soda” lignin as used in the present process refers to a lignin extracted from the black liquor resulting from the soda pulping process. In the soda process, sodium hydroxide is used in cooking the fibrous plants in pressurized reactors, at 140-170° C. The process separates the lignin from the cellulosic materials, generating a degraded and solubilized lignin in an aqueous black liquor phase, also containing other components. The black liquor phase is separated from the solid-containing cellulosic phase (the pulp). Soda lignin can be precipitated from the black liquor. About 10% of the total chemical pulp produced is non-wood based. For these, soda pulping is the predominant method of pulping.

In some embodiments, the Kraft or soda lignin that can be used to make the sulfonated lignin-containing composition can be extracted from the black liquor derived from wood species, such as from softwood or hardwood. These lignins can be referred to as “softwood Kraft lignin” and “softwood soda lignin” when derived from softwood, or “hardwood Kraft lignin” and “hardwood soda lignin” when derived from hardwood. In an alternative embodiment, the Kraft or soda lignin can be extracted from the black liquor derived from a non-wood agricultural species, such as from cereal plants (e.g. wheat straw, corn stover, etc.). These lignins extracted from non-wood species, are referred to as “agricultural Kraft lignin” and “agricultural soda lignin” in the present description.

In some embodiments, the hardwood Kraft or hardwood soda lignin can be extracted from the black liquor derived from the following hardwood species: poplar, elm, birch, beech, maple or eucalyptus, to name a few examples. Depending on the geographical region, other native hardwood species can also be used.

In other embodiments, the softwood Kraft or softwood soda lignin can be extracted from the black liquor derived from the following softwood species: spruces (black, white, red, Sitka and Engelmann), pines (jack, lodgepole, ponderosa), firs (Douglas, silver, Basalm), hemlocks, cedars or tamarack, to name a few examples. Depending on the geographical region, other native softwood species can also be used.

When the agricultural Kraft or agricultural soda lignin is extracted from the black liquor derived from non-wood agricultural species, these agricultural species can include corn stover, wheat straw, switchgrass, kenaf and bamboo, to name a few examples. Depending on the geographical region, other native non-wood species can also be used.

In some embodiments, the lignin used to prepare the sulfonated lignin can be a purified lignin. In some embodiments, a “purified lignin” can refer to a lignin extracted from a black liquor that has undergone a pre-oxidation step before acidification to reduce volatile organic components. Other examples of processes for obtaining a “purified lignin” can include optimized filtration strategies aiming to reach better physical separation or washing of the precipitated lignin from the black liquor. Typically, such purification strategies are geared to reduce or control the non-lignin constituents, while keeping the nature of the lignin material substantially unchanged from that typically present in the black liquor. The “purified lignin” can be a lignin with a reduced hem icellulose or sugar content. In some embodiments, the purified lignin can be a softwood or hardwood Kraft lignin extracted through the Westvaco™ (see e.g. U.S. Pat. No. 2,623,040), LignoBoost® (see e.g. U.S. Pat. No. 8,172,981), or LignoForce™ (see e.g. U.S. Pat. No. 9,091,023) processes or similar processes.

In some embodiments, the purified lignin that can be used in the present process can be characterized by a post purification pH of from about 1 to about 10. In particular embodiments, the purified lignin can have a post purification pH of from about 1 to about 5, or from about 5 to about 10.

A non-exhaustive list of commercial lignins that can be used in the present process include Biochoice™ Lignin (Domtar), West Fraser Lignin Type A (West Fraser), West Fraser Lignin Type B (West Fraser), Indulin™ A (Ingevity), Lineo™ Lignin (Stora Enso) and New Products 101 and 102 (Suzano).

The lignin to be used is typically supplied as a solid product with a solids content between 40% and 100%, depending on whether a drying step was used in the purification process, and may be used as is. The lignin can be mixed with the water in the form of a powder, a cake or a mixture thereof, to prepare the lignin-containing aqueous suspension. If the lignin is used in the form of a cake, the cake should preferably be exempt from significant chunks of solidified masses. A large mesh sieve (e.g. meshes of a few inches width) can be used to break apart coarse agglomerates if needed. The preparation of the lignin suspension can be made either by addition of the lignin to the water, addition of water to the lignin in the reaction vessel, or alternate additions of water and lignin. Addition of the lignin to the vessel can be performed through any physical transfer technique (e.g. belt or screw conveyor). The mixing of the lignin with water can be performed at room temperature. As an alternative, hot water, or even fresh (and still warm) lignin cake can be used to prepare the suspension. In some embodiments, the lignin can be mixed with water at a temperature from about 3° C. to about 80° C.

The quantity of lignin and water for preparing the lignin-containing aqueous suspension can be selected such that the solids content of the lignin-containing aqueous suspension is at most about 45 wt % based on the total weight of the suspension. The solids content can be at maximum about 45 wt % to limit the viscosity of the suspension. In some embodiments, the solids content of the aqueous lignin suspension can range from about 15 wt % to about 45 wt %, or even from about 30 wt % to about 45 wt %.

The “solids content” of any solution, mixture, suspension, as used herein, refers to the solids content or dry matter content. The solids content includes both the suspended solids and dissolved solids in the solution, mixture, suspension. The total solids content is expressed as a ratio of weights obtained before and after drying and/or solvent (e.g. water) evaporation.

The pH of the lignin-containing aqueous suspension, i.e. before sulfonation, is advantageously greater than about 6. In some implementations, the pH of the lignin-containing aqueous suspension can range from about 6 to about 12. In other embodiments, the pH of the aqueous lignin suspension before addition of the sulfonation agent can be higher than the sulfonation pH.

Depending on the lignin used, the pH of the lignin-containing aqueous suspension can vary. For instance, depending on the extraction treatment, the pH of the lignin can be any value between about 1 and about 10. Therefore, in some embodiments, a base can be used to reach the desired pH in the aqueous lignin-containing suspension, i.e. a pH greater than about 6, or from about 6 to about 12. If, in some embodiments, a base is required to adjust the pH of the suspension, this base can be chosen from a metal hydroxide, a metal bicarbonate, metal carbonate, NH4OH or a mixture thereof. For instance, the base can be NaOH, KOH, NaHCO₃, Na₂CO₃, KHCO₃, K₂CO₃, NH₄OH or any mixture thereof. In preferred embodiments, the base can be NaOH. The base can be used in solution in water at various concentrations. The amount of base to be used can be determined to correlate to a specific desired pH.

The base can be added to the water prior to mixing with the lignin or can be added to the suspension containing the lignin and water. Alternatively, the lignin can be added to the base in solution. The pH of the lignin-containing suspension can be monitored if desired, using common techniques to measure the pH of a liquid (e.g. electronic pH meter). Once prepared, the lignin suspension (base adjusted or not) can be keep for a while before being used in the next steps.

In some implementations, the preparation of the lignin-containing aqueous suspension can be performed in the presence of at least one surface-active agent. In some implementations, such as when addition of the lignin to the water is performed at lower mixing speeds for instance, the use of surface-active agent can prevent or limit the formation of a foam at the surface of the suspension. In some implementations, the surface-active agent can first be added to the water and then the lignin is added to the resulting water solution. The surface-active agent can be any wetting agent, defoaming agent or surfactant known in the art. In some implementations, the surface-active agent can be suitably selected not only for preventing foaming of the suspension of the lignin at the step of preparing the lignin-containing aqueous suspension, but also to serve as the defoaming agent in the final dispersant formulation that can be used in concrete mixes for instance. In this manner, the same surface-active agent can serve to prevent foaming of the lignin suspension in the first step of the process and can serve as an efficient defoaming agent in concrete mixes.

In further implementations, the preparation of the lignin-containing aqueous suspension can also be performed under heating at a relatively low temperature, such as between about 35° C. and about 70° C., e.g., at about 40° C. Smoothly heating the lignin aqueous suspension can allow reducing the viscosity of the mixture during the pH adjustment of the lignin suspension, if desired.

Various type of vessels or reactors can be used to mix the lignin with water and optionally the base, to prepare the lignin suspension. The reactor can be designed or chosen to ensure that the lignin suspension that is generated does not include or only includes a very limited quantity of agglomerates and that insoluble portions of lignin do not settle in the reactor vessel, before carrying out the heating and sulfonation steps of the process. To that end, any reactor and impeller design targeting a speed and shear rate high enough to break apart the initial lignin and prevent sedimentation can be suitable. For instance, the following systems can be used for obtaining a suitable aqueous lignin suspension: impellers including impellers and blades aimed at radial, axial flow or both. The impellers can be top-entering impellers (straight, angled and/or off-centre impellers), anchor type impellers (standard or helical) with or without reactor scrapping devices (ex. spring loaded or flexible material scrappers), or side-entering impellers which can be used alone or conjointly with a top-entering impeller. In some implementations, reactor baffles of adapted baffle size can be used.

The above described systems should typically be enough to obtain a suitable lignin suspension. If necessary, in some implementations, one could use other systems such as jet mixers for continuously recycling of the material inside the reactor (e.g. bottom to top) through the use of an external pump. Moreover, a draft tube with an internal top-impeller and an upwards or downwards flow could also be used. In further implementations, for instance if lignin agglomerates remain in the suspension before performing the next steps of the process, high-shear mixing can be used to favorize breakage of the agglomerates.

### Heating the Lignin-Containing Aqueous Suspension

Once the lignin-containing suspension has been prepared with the desired solids content and pH, the suspension can be heated in the next step, and before sulfonation, to reach a temperature at least about 65° C. and up to about 160° C. The heating can be performed under stirring in the vessel where the suspension was prepared, or in at least one supplementary vessel.

In some embodiments, the lignin-containing aqueous suspension can be heated to a temperature of at least about 65° C. and less than 160° C. In other embodiments, the lignin-containing aqueous suspension can be heated to a temperature from about 80° C. to about 140° C., or from about 65° C. to about 140° C., or about 65° C. to about 95° C., or from about 70° C. to about 95° C., or from about 75° C. to about 95° C., or from about 80° C. to about 95° C., before the sulfonation. In other embodiments, the lignin-containing aqueous suspension can be heated to a temperature from about 70° C. to about 90° C., or from about 75° C. to about 90° C., or from about 80° C. to about 90° C., before the sulfonation. In further embodiments, the lignin-containing aqueous suspension can be heated to a temperature from about 85° C. to about 95° C., or from about 90° C. to about 95° C., before the sulfonation. For some implementations, the temperature at which the lignin-containing aqueous suspension is heated, before sulfonation, can range from about 80° C. to about 85° C., or from about 85° C. to about 90° C.

Through heating the lignin-containing aqueous suspension to at least about 65° C., the lignin can partially solubilize in the water until reaching a suitable solubility degree at which agglomeration of the lignin particles remaining in suspension can be limited or avoided. Limiting or avoiding agglomeration of the lignin particles can in turn allow increased accessibility of the reactive groups on the lignin aliphatic moieties, which will react with the sulfonating agent in the next step. Hence, limiting or avoiding agglomeration of the lignin particles can impact the sulfonation degree and kinetics of the lignin in the next step, which can both be increased. It is worth noting that in addition to heating, the stirring of the lignin suspension can further enhance the dispersion of the lignin particles to some extent.

In some implementations, the benefit of the heating step on limiting agglomeration of the lignin particles can be observed as soon as the suspension has reached the targeted heating temperature (e.g. at least 65° C.). In some embodiments, the suspension can be heated for a certain period, for example a few minutes, to ensure that there is no or substantially no agglomeration. Further advantages of the heating step will also be described below in connection with the sulfonation step.

The prior sulfonation heating step does not substantially impact the pH of the suspension.

### Sulfonation of the Lignin

Once the lignin-containing suspension has been heated, a sulfonating agent is added to the heated lignin-containing aqueous suspension. The purpose of adding the sulfonating agent is to sulfonate the sulfonatable groups of the lignin and therefore form a sulfonated lignin product. By “sulfonatable” groups of the lignin, one refers to the chemical groups of the lignin that can react with the sulfonating agent to form sulfonate groups on the lignin. The sulfonatable groups can thus include alkenes and aliphatic sites adjacent of in proximity to hydroxyl groups, thiols, mercaptans, ethers, thioethers, etc. In some embodiments, the sulfonation can be performed by adding the sulfonating agent directly in the heated lignin-containing aqueous suspension, in the same vessel that was used to prepare the initial lignin aqueous suspension. Alternatively, the heated lignin-containing aqueous suspension can be transferred to at least one supplementary vessel prior to the addition of the sulfonating agent. The reaction can be performed under stirring. The addition of the sulfonating agent can be performed in one or more addition steps.

In some embodiments, the sulfonation step can include adding the sulfonating agent to the heated lignin-containing aqueous suspension, in solid form, in suspension, in solution, or as a gas.

The sulfonating agent is selected to generate a sulfite ion, a bisulfite ion or a mixture of sulfite and bisulfite ions in the heated aqueous lignin suspension. In some embodiments, the sulfonating agent can be selected from gaseous sulfur dioxide (SO₂), sodium sulfite, potassium sulfite, sodium bisulfite, potassium bisulfite, sodium metabisulfite, potassium metabisulfite and mixtures thereof. Sodium sulfite, sodium bisulfite, sodium metabisulfite or mixtures thereof can be preferably used as sulfonating agent, in some embodiments.

The sulfonating agent can be added to the heated lignin-containing aqueous suspension in a molar ratio of the sulfonating agent to the lignin ranging from about 0.1:1 to about 1.5:1. The molar ratio of the sulfonating agent to the lignin is expressed on a sulfite to monomeric lignin sub-unit basis, meaning that the molar ratio is based on the molar ratio of sulfite anions to monomeric lignin sub-units. In some embodiments, the molar ratio of the sulfonating agent to the lignin can be between about 0.1:1 to about 0.6:1 on a sulfite to monomeric lignin sub-unit basis. In another embodiment, the molar ratio of the sulfonating agent to the lignin can be between about 0.15:1 to about 0.3:1 on a sulfite to monomeric lignin sub-unit basis. “Monomeric lignin sub-unit” is understood to refer to the average monolignol subunit present in the polymeric lignin and is meant to include all chemical and structural variants typically derived from individual monolignols by biological processes, chemical pulping, extraction or purification processes.

Additional benefit of the prior heating step can be observed upon addition of the sulfonating agent to the lignin-containing suspension. Indeed, the addition of the sulfonating agent after the heating step, which can allow the lignin containing mixture to first achieve higher, but still incomplete, solubility at a higher temperature, results in little to no agglomerate forming upon addition of the sulfonating agent. Limited to no agglomeration is observed in such condition in a subsequent period of mixing the suspension containing the sulfonating agent or heating to the desired sulfonation temperature.

In contrast, if there is no prior heating step of the lignin-containing aqueous suspension, large agglomerates can form in the reaction vessel, either upon addition of the sulfonating agent or during a subsequent heating step to achieve the desired sulfonation temperature. Higher solids content (above 20 wt %) and lower reaction pH (below 10) further increase the formation and size of agglomerates. In the most problematic scenarios, a single agglomerated mass can often occupy the entire vessel. This phenomenon is observed even in the presence of baffles and stirring speeds upwards of 600 rpm, and it can take from several minutes to several hours before the agglomerates resorb.

The present process, thanks to the heating step carried out before addition of the sulfonating agent, can allow avoiding the above described problems.

The sulfonation is advantageously performed under heating and can be performed in the same vessel as that used for the addition of the sulfonating agent, or in at least one supplementary vessel. The sulfonation can also be performed as part of a continuous process. In some embodiments, the sulfonation temperature can be at least about 90° C. and up to about 160° C. In other embodiments, the sulfonation temperature can range from about 95° C. to about 130° C. In alternative embodiments, the sulfonation can be performed at a temperature ranging from about 100° C. to about 130° C., or from about 100° C. and 120° C. In some embodiments, the sulfonation temperature can be more than 100° C. Therefore, the sulfonation temperature can be at least 101° C., 102° C., 103° C., 104° C., 105° C., 106° C., 107° C., 108° C., 109° C., or 110° C. The sulfonation temperature can be from 105° C. to about 160° C., or from 105° C. to about 150° C., or from 105° C. to about 140° C., or from 105° C. to about 130° C., or from 105° C. to about 120° C., or from 105° C. to about 125° C., or from about 110° C. to about 120° C., or from about 110° C. to about 125° C., or from or from 115° C. to about 125° C. Performing the sulfonation step a high temperature can further prevent agglomerations from forming during or in the period following the addition of the sulfonation agent.

During the sulfonation step, the solids content of the lignin-containing aqueous suspension can be maintained at about 20 wt % to about 45 wt %. In some embodiments, the solids content of the lignin-containing aqueous suspension can be maintained at about 30 wt % to about 45 wt %, during the sulfonation. In some embodiments, additional water can be added to the mixture during the sulfonation step, to adjust the solids content. Addition of water can also allow adjusting the sulfonation temperature.

The sulfonation step can be performed at a sulfonation pH ranging from about 6 to about 11. In some embodiments, the pH of the reaction mixture during the sulfonation can be from about 6.5 to about 11. In other embodiments, the sulfonation pH can range from about 6.5 to about 10.5. In further embodiments, the sulfonation pH can be from about 8.5 to about 10.5. According to some embodiments, the pH of the lignin-containing aqueous suspension during sulfonation can be lower than the pH of the lignin-containing aqueous suspension before addition of the sulfonating agent.

It can be possible to monitor the pH of the reaction mixture during the sulfonation step to ensure that it can be maintained in a range from about 6 to about 11, or from about 6.5 to about 11, or from about 6 to about 10.5, or from about 6.5 to about 10.5, or from about 8.5 to about 10.5. In some embodiments, if the pH is too low, additional base can be added to the reaction mixture during sulfonation to increase the pH. In some embodiments, the addition of more base solution during sulfonation, to adjust the sulfonation pH, can also allow adjusting the sulfonation temperature.

The pH of the mixture can be impacted by the addition of the sulfonating agent, depending on the choice of sulfonating agent added. In some embodiments, it can be desired to adjust the pH and the solids content of the reaction mixture during sulfonation. This can be performed through addition of more water and base to the reaction mixture. The further addition of water can in turn allow adjustment of the sulfonation temperature.

Depending on the lignin raw material source, one can also observe different behavior with respect to agglomeration of the lignin particles, during or after the addition of the sulfonating agent. If a lignin type appears to agglomerate more than another one, it can be advantageous to add further water to increase dilution or to add further base to increase the pH, while staying within the above-mentioned solids content and pH ranges, to move the process back towards desirable agglomeration-free conditions.

In further embodiments, the sulfonation step can be performed by addition of the sulfonating agent in more than one addition step. Hence, the sulfonating agent can be added to the lignin-containing aqueous suspension in more than one portion. In some implementations, the sulfonation step can involve addition of a first portion of the sulfonating agent to the lignin-containing aqueous suspension heated at a first temperature to obtain a first mixture comprising the sulfonating agent and the lignin. The addition of the sulfonating agent can be performed in one or more addition steps. Then, the first mixture can be stirred at the first temperature to obtain a second mixture containing a partially sulfonated lignin. In some implementations, the stirring at the first temperature can be carried out for up to about 90 minutes, but this period of time can be adjusted. The remaining portion of the sulfonating agent can then be added to the second mixture in one or more addition steps, to obtain the desired sulfonated lignin composition. In other implementations, the sulfonation step can include addition of a first portion of the sulfonating agent at a first temperature and at least one further portion at a second temperature that is higher than the first temperature. Therefore, in such implementations, the first portion of the sulfonating agent is added in one or more addition steps to the lignin-containing aqueous suspension which is heated at a first temperature. This results in a first mixture, which is then stirred at the first temperature to obtain a second mixture containing a partially sulfonated lignin. In some implementations, the stirring at the first temperature can be carried out for up to about 90 minutes, but this period of time can be adjusted. The second mixture can then be heated at a second temperature higher than the first temperature and then stirred at the second temperature to form a third mixture. The lignin in the third mixture is thus further sulfonated compared to the partially sulfonated lignin in the second mixture. In some implementations, the stirring at the second temperature can be performed for up to about 90 minutes, however this period of time can be adjusted. In some implementations, the stirring at the first temperature can be performed for a period of time that is the same or different than the period of time during which the stirring at the second temperature is performed. Then, the remaining portion of the sulfonating agent can be added to the second mixture in one or more addition steps, at the second temperature, to obtain the desired sulfonated lignin composition. In some implementations, the first temperature can be from about 80° C. to about 95° C. In some implementations, the second temperature can be about 10° C. to about 30° C. higher than the first temperature. In other implementations, the first temperature can be from about 80° C. to about 95° C. and the second temperature can be from about 90° C. to about 105° C. In some implementations, the addition of the different portions of the sulfonating agent can be followed by an adjustment of the sulfonation temperature, solids content and/or pH of the solution. The sulfonation pH and the solids content can be adjusted by addition of water and/or base. In some implementations, the stepwise addition of the sulfonating agent can enhance the solubility of the lignin material, which can be impacted upon modification of the reaction pH, following the addition of the sulfonating agent. The time period between each addition, during which the reaction mixture is stirred at the first or second temperature, can further serve to gradually improve the solubility of the lignin in suspension. This, in turn, can reduce the impact of the subsequent additions on the viscosity/presence of agglomerates in the reaction mixture, as the case may be.

In some embodiments, the sulfonation reaction can be carried out for at least about 1 hour. In other embodiments, the sulfonation reaction time can be between about 1 hour and about 12 hours. In some embodiments, the sulfonation reaction can last between about 5 hours and about 12 hours, or between about 2 hours to about 6 hours, or between about 3 hours to about 5 hours. It is to be understood that if the sulfonation reaction is performed in more than one sulfonating agent addition steps as explained above, the sulfonation reaction times include all these steps. In some implementations, it can be possible to collect a reaction mixture sample to measure the degree of charges in the sample and assess whether the reaction is completed. In some embodiments, the reaction time can also be adjusted to provide a sulfonated lignin-containing composition with a desirable viscosity. For instance, a longer reaction time can provide a product of adequate performance with a desirable viscosity. Nevertheless, shorter reaction time can still provide a product of adequate performance, but at a higher and less desirable viscosity. However, the viscosity can be further adjusted, if required, by adding water or increasing the pH to the final composition.

Upon addition of the sulfonating agent, reactive groups on the aliphatic moieties of the lignin (e.g. alkenes and aliphatic sites adjacent of in proximity to hydroxyl groups, thiols, mercaptans, ethers, thioethers, etc) can be reacted to form aliphatic sulfonate groups on the lignin. Aromatic moieties can also react with the sulfonating agent to a limited extent. However, the process conditions can allow primarily sulfonating the lignin aliphatic moieties. Indeed, as explained above, the process conditions before addition of the sulfonated agent allow for the lignin particles to be readily suspended in the water solution with no or substantially no agglomeration of the lignin particles. This, in turn, can allow a better accessibility to multiple regions of the lignin, increasing speed of sulfonation, and preventing further agglomerations upon addition of the sulfonating agent. More specifically, the process conditions can increase accessibility of the sulfonatable groups on the aliphatic moieties of the lignin, which can then readily react with the sulfonating agent. In addition, the sulfonation conditions themselves, including for instance the high sulfonation temperature, can favorize the solubilization of the sulfonated lignin to an important extent, which in turn can improve reactivity of the sulfonatable groups on the aliphatic moieties towards sulfonation.

In some embodiments, the aromatic moieties of the lignin can be substantially unsulfonated, meaning that the sulfonating agent does not react or only reacts to a negligible extent with the aromatic moieties of the lignin. Since the aliphatic moieties of the lignin are rendered accessible thanks to the process conditions, such as the pre-sulfonation heating step and also the high temperature sulfonation, the sulfonating agent can react primarily with aliphatic moieties of the lignin and the aromatic moieties may not or substantially not react. Therefore, one can obtain an optimal sulfonation degree of the aliphatic moieties of the lignin, which will improve upon the unmodified lignin in terms of performance of the final composition as dispersant or water reducer in the various intended applications, as will be detailed below. The present process can thus allow introducing sulfonate functions on the aliphatic moieties of the lignin without requiring a step of functionalizing or graft polymerizing the lignin to introduce side chains containing reactive groups on the lignin, before sulfonation. For instance, the present process distinguishes from known sulfomethylation processes involving the use of formaldehyde followed by sulfite additions, in which the modifications are non-exclusive and both aromatic and aliphatic groups of the lignin are either sulfomethylated or sulfonated.

### Cooling Step Post Sulfonation

After the sulfonation step of the process, the reaction mixture, containing the sulfonated lignin dispersed in water can be cooled to avoid or limit any decomposition of the sulfonated lignin. The resulting cooled sulfonated lignin-containing mixture could be used as is, meaning that a ready-to-use product can be obtained after the cooling step. However, as will be explained below, the cooled sulfonated lignin-containing mixture can also receive additional optional treatments.

In some embodiments, the sulfonated lignin-containing mixture can be cooled to a temperature below 80° C., at which decomposition of the sulfonated lignin can be avoided or limited. In particular embodiments, the sulfonated lignin-containing mixture can be cooled to a temperature below 70° C., or even below 65° C.

Various means can be used to cool the sulfonated lignin-containing mixture. For instance, one could use a cooling bath, in-reactor cooling coils or plates, cooling jackets or any other cooling method known in the field. In alternative or complementary embodiments, cooling can be performed by addition of water to the sulfonated lignin-containing mixture. Through addition of water to cool the mixture, one can also adjust the solids content and thus the viscosity of the composition. In some embodiments, water can be added to cool the sulfonated lignin-containing mixture and a cooled sulfonated lignin-containing mixture with a solids content of from about 20 wt % to about 45 wt % can be obtained. Therefore, by using water to cool the mixture during the cooling step, one can “customize” the composition for having a desired solids content and associated viscosity. For instance, one can adjust the solids content to reach a viscosity of less than about 1000 cP for obtaining a pumpable composition. However, the solids content and associated viscosity can be adjusted to any desirable value. The so-customized mixture can then be used directly, as is, for various applications, which will be detailed below.

### Optional Additional Steps

As mentioned above, the sulfonated lignin-containing mixture obtained after the cooling step can be ready-to-use for some intended applications. However, in some embodiments, the sulfonated lignin-containing mixture can receive further additional treatments as will now be detailed.

In some embodiments, it can be desired to further adjust the pH of the sulfonated lignin-containing mixture after cooling. For instance, one can adjust the pH of the cooled sulfonated lignin-containing mixture to reach a pH from about 8 to about 13.5. In some embodiments, the pH of the cooled sulfonated lignin-containing mixture can be adjusted to reach a value from about 8 to about 13 when the cooled mixture is at a temperature below 80° C., or below 70° C., or even below 65° C. In some embodiments, the pH of the sulfonated lignin-containing mixture after cooling, can be adjusted to reach a pH from about 11 to about 13. Cooling the sulfonated lignin-containing mixture before adjustment of pH can prevent degradation of the product upon addition of a base, which can result in a decreased dispersing ability.

Adjustment of the pH of the sulfonated lignin-containing mixture, post-cooling, can be carried out by addition of a base which can be the same or different than the base optionally used in the mixing or sulfonation steps. The base used for adjusting the pH of the cooled sulfonated lignin-containing mixture can be chosen from a metal hydroxide, a metal bicarbonate, metal carbonate, NH₄OH or a mixture thereof. For instance, the base can be NaOH, KOH, NaHCO₃, Na₂CO₃, KHCO₃, K₂CO₃, NH₄OH or any mixture thereof. In preferred embodiments, the base used to adjust the pH of the cooled sulfonated lignin-containing mixture can be NaOH.

In some embodiments, the sulfonated lignin-containing mixture before cooling or post-cooling, can undergo further treatments, such as a treatment for reducing the content of volatile organic compounds (VOCs) in the sulfonated lignin-containing mixture. VOCs observed in the process product may include residual volatile sulfur-based compounds and terpenoids, in ppm or sub-ppm levels. This VOC-reducing step can allow obtaining a product presenting reduced odors.

In some embodiments, the reduction of the VOCs can be performed through gaz stripping or evaporation from the mixture, prior to or after the cooling step, or at any intermediate temperature. Alternatively, reduction of the VOCs can be done by bubbling an oxidative gas such as O₂ or air in the sulfonated lignin-containing mixture. In another embodiment, removal of the VOCs can include a treatment of the sulfonated lignin-containing mixture by a peroxide or ozone. In some embodiments, one can combine one or more of the above-described methods to reduce the VOCs content of the sulfonated lignin-containing mixture.

In further embodiments, the sulfonated lignin-containing mixture can undergo a treatment to remove residual sulfites therefrom. This can be beneficial for compatibility with certain additives (for example, additives which contain calcium salts). This treatment can involve precipitating the sulfites out of the sulfonated lignin-containing mixture, which can be performed either before or after the cooling step. A pH adjustment can be required as part of the precipitation step. With such a treatment, one can obtain a sulfite-free sulfonated lignin-containing mixture. In some embodiments, the sulfite precipitation can be performed by forming an insoluble sulfite salt by addition of salt or base to the sulfonated lignin-containing mixture. Then, a physical separation of the insoluble sulfite salt can be carried out to recover the sulfite-free sulfonated lignin-containing mixture. In some embodiments, the salt added to precipitate the sulfites can be calcium hydroxide or calcium oxide and the resulting insoluble sulfite salt is therefore calcium sulfite. The physical separation to remove the insoluble sulfite salt can be deposition or a filtration.

In further embodiments, the process can include an additional drying step to obtain the sulfonated lignin product in solid form, e.g., in powder form. While the sulfonated lignin-containing composition can directly be used as a solution in water, it can be advantageous, in some implementations, to dry the composition to recover a solid product. For instance, it can be easier to transport or stock a solid product since this would require less space. If a drying step is implemented, i.e., to remove water from the sulfonated lignin-containing mixture, this drying can be performed using any methods known in the field. For instance, one can dry the sulfonated lignin-containing mixture, which can be sulfite-free, using a spray dryer, spin flash dryer or drum dryer. Some VOCs which may be present in the mixture if no treatment was performed before to remove them, can be removed from the product during this drying step.

In other embodiments, the deep eutectic solvent is selected from the group consisting of metal salt+organic salt, metal salt hydrate+organic salt, organic salt+hydrogen bond donor, metal salt hydrate+hydrogen bond donor, 1-butylimidazolium chloride:copper chloride:zinc chloride, 1-butyl-1-methylpyrrodlidinium bromide:choline chloride:glycerol, 1-butyl-3-methylimidazolium chloride:zinc chloride, 1-butyl-3-methylimidazolium chloride:zinc chloride:acetamide, 1-butyl-3-methylimidazolium chloride:zinc chloride:dimethylurea, 1-butyl-3-methylimidazolum bromide:Urea:zinc bromide, 1-butyl-3-methylimidazolum bromide:zinc bromide:acetamide, 1-butyl-3-methylimidazolum bromide:zinc bromide:dimethylurea, 1-butyl-3-methylimidazolum chloride:glycerol:zinc bromide, 1-butyl-3-methylimidazolum chloride:lithium chloride, 1-butyl-3-methylimidazolum chloride:zinc bromide:acetamide, 1-butyl-3-methylimidazolum chloride:zinc chloride, 1-butyl-3-methylimidazolum chloride:zinc chloride:acetamide, 1-butyl-3-methylimidazolum chloride:zinc chloride:urea, 1-ethyl-3-butylbenzotriazolium hexafluorophosphate:imidazole, 1-ethyl-3-methyl imidazolium chloride:diethylenetriamine:ethylene Glycol, 1-ethyl-3-methyl imidazolium chloride:diethylenetriamine:diethylene Glycol, 2-(acetyloxy)-N,N,N-trimethylethanaminium chloride:urea, 2-acetyloxy-N,N,N-trimethylethanaminium chloride:tin(II) chloride, 2-acetyloxy-N,N,N-trimethylethanaminium chloride:zinc bromide, 2-chloro-N,N,N-trimethylethanaminium chloride:urea, 2-fluoro-N,N,N-trimethylethanaminium bromide:urea, 4-amino-1,2,4-triazole:glycerol:resorcinol, acetamide:diethylenetriamine:diethylene glycol, acetamide:diethylenetriamine:ethylene glycol, acetamide:urea:glycerol, acetamide:urea:sorbitol, acetamide:zinc chloride, allyltriphenylphosphonium bromide:diethylene glycol, aluminum ammonium sulfate:urea, aluminum chloride:acetamide, aluminum chloride:urea, aluminum nitrate:urea, ammonium chloride:melamine:lactic acid, benzyltriethylammonium chloride:toluenesulfonic acid, benzyltrimethylammonium chloride:toluenesulfonic acid, benzyltriphenylphosphonium chloride:ethylene glycol, benzyltriphenylphosphonium chloride diethylene glycol, benzyltriphenylphosphonium chloride:glycerol, betaine:1,2-propanediol:lactic acid, betaine:1,3-propanediol:lactic acid, betaine:ethylene glycol:glycerol, betaine:diethylene glycol:glycerol, betaine:ethylene glycol:lactic acid, betaine:dietheylene glycol:lactic acid, betaine:glycerol:citric acid, betaine:citric acid, betaine:sucrose, betaine:sucrose:proline, betaine:urea:glycerol, choline acetate:ethylene glycol, choline acetate:diethylene glycol, choline acetate:glycerol, choline acetate:urea, choline chloride:1,2,4-triazole:ethylene glycol, choline chloride:1,2,4-triazole:diethylene glycol, choline chloride:1,4-butanediol, choline chloride:1-methylurea, choline chloride:2,2,2-trifluroacetamide, choline chloride:acetamide, choline chloride:acetamide:lactic acid, choline chloride:acetic acid, choline chloride:cromium(III) chloride, choline chloride:ethylene glycol, choline chloride:ethylene glycol:lactic acid, choline chloride:ethylene glycol:urea, choline chloride:diethylene glycol, choline chloride:diethylene glycol:lactic acid, choline chloride:diethylene glycol:urea, choline chloride:fructose, choline chloride:glucose, choline chloride:glucose, choline chloride:glucose, choline chloride:glucose:glycerol, choline chloride:glutaric acid, choline chloride:glycerol, choline chloride:glycine, choline chloride:glycolic acid, choline chloride:imidazole, choline chloride:imidazole:ethylene glycol, choline chloride:imidazole:diethylene glycol, choline chloride:itaconic acid, choline chloride:L-(+)-tartaric acid, choline chloride:lactic acid, choline chloride:lactic acid:urea, choline chloride:lactose, choline chloride:levulinic acid, choline chloride:magnesium Chloride, choline chloride:malonic acid, choline chloride:malonic Acid:1,2-propanediol, choline chloride:malonic Acid:1,3-propanediol, choline chloride:maltose, choline chloride:mannitol, choline chloride:o-cresol, choline chloride:oxalic Acid, choline chloride:oxalic Acid:1,2-propanediol, choline chloride:phenol, choline chloride:phenol:diethylene glycol, choline chloride:phenol:ethylene glycol, choline chloride:phenylacetic acid, choline chloride:phenylpropionic acid, choline chloride:propionic acid, choline chloride:raffinose, choline chloride:resorcinol, choline chloride:sorbitol, choline chloride:sorbitol, choline chloride:sorbitol, choline chloride:sorbitol, choline chloride:sorbitol:glycerol, choline chloride:sucrose, choline chloride:tetrazole:diethylene glycol, choline chloride:tetrazole:ethylene glycol, choline chloride:tin(II) chloride, choline chloride:toluenesulfonic acid, choline chloride:triethylene glycol, choline chloride:urea, choline chloride:arginine, choline chloride:urea:glycerol, choline chloride:urea:lactic acid, choline chloride:xylenol, choline chloride:xylitol, choline chloride:xylitol:glycerol, choline chloride:xylose, choline chloride:zinc bromide, choline chloride:zinc chloride, choline chloride:zinc nitrate, choline chloride:1,4-butanediol, choline fluoride:urea, choline nitrate:urea, citric acid:adonitol, citric acid:alanine, citric acid:alanine:lactic acid, citric acid:choline chloride, citric acid:dimethylurea, citric acid:maltose, citric acid:proline, citric acid:proline:glycerol, citric acid:proline:lactic acid, citric acid:raffinose, citric acid:ribitol, citric acid:sorbose, citric acid:sucrose, citric Acid:xylitol, diethylethanolammonium chloride:copper chloride:diethylene glycol, diethylethanolammonium chloride:copper chloride:ethylene glycol, ethylammonium chloride:1-(trifluoromethyl) urea, ethylammonium chloride:methylurea, ethylammonium chloride:urea, ethylammonium chloride:Zinc chloride:glycerol, ethylene glycol:iron(III) chloride, ethylene glycol:tin(II) chloride, ethylene glycol:zinc chloride, diethylene glycol:iron(III) chloride, diethylene glycol:tin(II) chloride, diethylene glycol:zinc chloride, fructose:glutamine:zinc chloride, fructose:urea:sodium chloride, fructose:glycine:zinc chloride, glucose:dimethylurea:ammonium chloride, glucose:glutamine:zinc chloride, glucose:glycine:zinc chloride, glucose:urea, glucose:urea:ammonium chloride, glucose:citric acid, glucose:malic acid, lactic acid:alanine, lactic acid:betaine, lactic acid:glycine, lactic acid:histidine, lactic acid:proline, lactose:dimethylurea:ammonium chloride, malic acid:alanine, malic acid:Alanine:Lactic acid, malic acid:betaine, malic acid:choline chloride, malic acid:choline chloride:glycerol, malic acid:glycine, malic acid:histidine, malic acid:nicotinic acid, malic acid:proline, malic acid:proline:lactic acid, maltose:dimethylurea:sodium chloride, maltose:dimethylurea:sodium chloride, mannose:dimethylurea, menthol:camphor, methyltriphenylphosphonium bromide:ethylene glycol, methyltriphenylphosphonium bromide:diethylene glycol, methyltriphenylphosphonium bromide:glycerol, methyltriphenylphosphonium bromide:glycerol:diethylene glycol, methyltriphenylphosphonium bromide:glycerol:ethylene glycol, methyltriphenylphosphonium bromide:triethylene glycol, methyltriphenylphosphonium bromide 2,2,2-trifluoroacetamide, N-(2-hydroxyethyl)-N,N-dimethylanilinium chloride:Iron(III) Chloride, N-(2-hydroxyethyl)-N,N-dimethylanilinium chloride:Tin(II) Chloride, N,N,N-trimethyl(phenyl)methanaminium chloride:urea, N,N-diethylethanolammonium chloride:ethylene glycol, N,N-diethylethanolammonium chloride:diethylene glycol, N,N-diethylethanolammonium chloride:glycerol, N,N-diethylethanolammonium chloride:triethylene glycol, N-benzyl-2-hydroxy-N-(2-hydroxyethyl)-N-methylethanaminium chloride:urea, N-benzyl-2-hydroxy-N,N-dimethylethanaminium chloride:urea, N-ethyl-2-hydroxy-N,N-dimethylethanaminium chloride:urea, N,N,N-trimethyl(phenyl)methanaminium chloride:urea, oxalic acid anhydrous:alanine, oxalic acid anhydrous:bentaine, oxalic acid anhydrous:benzyltrimethylammonium chloride, oxalic acid anhydrous:choline chloride, oxalic acid anhydrous:choline chloride:ethylene glycol, oxalic acid anhydrous:choline chloride:diethylene glycol, oxalic acid anhydrous:choline chloride:glycerol, oxalic acid anhydrous:proline, oxalic acid dihydrate:alanine, oxalic acid dihydrate:betaine, oxalic acid dihydrate:choline chloride, oxalic acid dihydrate:glycine, oxalic acid dihydrate:histidine, oxalic acid dihydrate:nicotinic acid, oxalic acid dihydrate:proline, phosphocholine chloride:dichloroacetic acid:lauric acid, potassium carbonate:ethylene glycol, potassium carbonate:diethylene glycol, potassium carbonate:glycerol, saccarose:Urea:calcium chloride, sorbitol:dimethylurea:ammonium chloride, sorbitol:urea:ammonium chloride, tetrabutylammonium bromide:imidazole, tetrabutylammonium bromide:lauric Acid:capric Acid, tetrabutylammonium bromide:oleic Acid:capric Acid, tetrabutylammonium chloride:ethylene glycol, tetrabutylammonium chloride:diethylene glycol, tetrabutylammonium chloride:glycerol, tetrabutylammonium chloride:toluenesulfonic acid, tetrabutylammonium chloride:triethylene glycol, tetrabutylammonium bromide:octanoic acid:thymol, tetrabutylphopsphonium chloride:toluenesulfonic acid, tetrapropylammonium bromide:ethylene glycol, tetrapropylammonium bromide:diethylene glycol, tetrapropylammonium bromide:glycol, tetrapropylammonium bromide:triethylene glycol, trimethylglycine:glycerin, trimethylglycine:glycolic acid, trimethylglycine:urea, urea:calcium chloride, urea:cromium(III) chloride, urea:iron(III) chloride, urea:tin(II) chloride, urea:zinc chloride and mixtures thereof.

### III. Methods of Making Blended Furnish

The invention provides methods of making and using a blended furnish.

In some embodiments, a method for preparing a blended furnish, can include adding a plurality of substrates; mixing a urea-formaldehyde (UF) resin or a melamine-urea-formaldehyde (MUF) resin optionally with an amine and water at a pH of 5-11, preferably 6-10; optionally adding one or more additives; adding a lignosulfonate salt, a kraft lignin or a sulfonated lignin and a deep eutectic solvent; optionally adding one or more additives to form the blended furnish, wherein the blended furnish has a buffer capacity of 2-200 mL of 0.1 N HCl by the Acid Titration Value (ATV) Method using 20 grams of blended furnish for a period of time up to 20 days.

In certain embodiments, the lignosulfonate is selected from the group consisting of calcium lignosulfonate, magnesium lignosulfonate, potassium lignosulfonate, chrome lignosulfonate, ammonium lignosulfonate, sodium lignosulfonate and mixtures thereof.

In other embodiments, a method for preparing a blended furnish, can include adding a plurality of substrates; mixing a urea-formaldehyde (UF) resin or a melamine-urea-formaldehyde (MUF) resin, a lignosulfonate salt, a kraft lignin or a sulfonated lignin and a deep eutectic solvent, optionally with an amine and water at a pH of 5-11, preferably 6-10; optionally adding one or more additives to form the blended furnish, wherein the blended furnish has a buffer capacity of 2-200 mL of 0.1 N HCl by the Acid Titration Value (ATV) Method using 20 grams of blended furnish for a period of time up to 20 days.

In further embodiments, the lignosulfonate is selected from the group consisting of calcium lignosulfonate, magnesium lignosulfonate, potassium lignosulfonate, chrome lignosulfonate, ammonium lignosulfonate, sodium lignosulfonate and mixtures thereof.

In some embodiments, a method for preparing a blended furnish, can include adding a plurality of substrates; mixing a lignosulfonate salt, a kraft lignin or a sulfonated lignin and a deep eutectic solvent with the substrates; adding a urea-formaldehyde (UF) resin or a melamine-urea-formaldehyde (MUF) resin optionally with an amine and water at a pH of 5-11, preferably 6-10; optionally adding one or more additives to form the blended furnish, wherein the blended furnish has a buffer capacity of 2-200 mL of 0.1 N HCl by the Acid Titration Value (ATV) Method using 20 grams of blended furnish for a period of time up to 20 days.

In other embodiments, the lignosulfonate is selected from the group consisting of calcium lignosulfonate, magnesium lignosulfonate, potassium lignosulfonate, chrome lignosulfonate, ammonium lignosulfonate, sodium lignosulfonate and mixtures thereof.

### IV. Composite Product

The invention provides a composite product using a blended furnish.

In some embodiments, a composite product, can include a plurality of substrates; and at least partially cured blended furnish, wherein the blended furnish, prior to curing, can include a urea-formaldehyde (UF) resin or a melamine-urea-formaldehyde (MUF) resin; a lignosulfonate, a kraft lignin or a sulfonated lignin; a deep eutectic solvent; an alkaline compound; optionally an additive; and a plurality of substrates, wherein the blended furnish has a buffer capacity of 2-200 mL of 0.1 N HCl by the Acid Titration Value (ATV) Method using 20 grams of blended furnish for a period of time up to 20 days.

In other embodiments, the composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

### V. Resin System

The present disclosure is directed to ready-to-use resin systems, applications containing the resin system, and methods of preparing the resin systems. The resin systems of the present invention contain urea and formaldehyde, and optionally melamine. The present inventors have found that a partial to total replacement of melamine in melamine-urea-formaldehyde (MUF) resin systems with an equivalent weight % of a lignosulfonate, can make a resin which is more environmentally friendly, while maintaining the same resin performance. This is especially significant since lignosulfonates are an eco-friendly component.

The resin system of the present invention may include a UF resin or MUF resin, prepared by:
a urea-formaldehyde (UF) resin or melamine-urea-formaldehyde (MUF) resin, prepared by:
   mixing a first set of components comprising one or more urea compounds and one or more formaldehyde compounds and optionally one or more melamine compounds, optionally heating while mixing for at least one minute to form a first reaction product having an initial molar ratio (IMR) of total moles of the one or more formaldehyde compounds to moles of the one or more urea compounds plus, if present, the one or more melamine compounds of from about 1.4:1 to 5:1, or about 1.4:1 to 3:1, or about 2,
   mixing the first reaction product with a second set of components comprising one or more urea compounds and a buffering and stabilizing agent and optionally one or more melamine compounds, optionally heating while mixing to form a UF resin or MUF resin, wherein the UF resin or MUF resin has a molar ratio (MR) of total moles formaldehyde to total moles urea plus, if present, the one or more melamine compounds of from about 0.25:1 to about 2.50:1, or from about 0.25:1 to about 1.5:1, and
   if the pH of the UF resin or MUF resin is not 6.5 to about 10.0, or from about 8.0 to about 10.0, or from about 8.0 to about 9.0 then one or more alkaline compounds may be mixed with the UF resin or MUF resin until the pH of the UF resin or MUF resin is 6.5 to about 10.0, or from about 8.0 to about 10.0, or from about 8.0 to about 9.0 to form the resin system,
      wherein one or more lignosulfonate compounds are included with the first set of components and/or with the second set of components in an amount of from about 0.1 wt. % to about 30 wt. %, or from about 1.0 wt. % to about 20 wt. %, or from about 1.0 wt. % to about 10 wt. %, based on a total weight of the resin system,
about 0.0 wt. % to about 40 wt. % of water, based on the total weight of the resin system, and
   wherein the resin system has a buffer capacity of 2 to 400 mL, or greater than 5 to 150 mL, preferably 20 to 60 mL of 0.1 N HCl by the ATV Method for a period of time of at least about 20 days at 25° C.

The UF or MUF resin is typically prepared in two steps. In the first step, a first set of components, comprising one or more urea compounds and one or more formaldehyde compounds, and optionally one or more melamine compounds, are heated while mixing for at least one minute to form a first reaction product. Preferably, the first set of components is heated to a temperature of from about 75° C. to about 100° C., or from about 80° C. to about 95° C. or from about 85° C. to about 90° C.

The first step of preparing the UF or MUF resin is typically made using a molar excess of formaldehyde. The one or more urea compounds, the one or more formaldehyde compounds, and if present, the one or more melamine compounds are present in amount such that the first reaction product has a molar ratio (IMR) of total moles of the one or more formaldehyde compounds to moles of the one or more urea compounds plus, if present, the one or more melamine compounds of from about 1.4:1 to 5:1, or about 1.4:1 to 3:1, or about 2. The one or more urea compounds in the first set of components may be present in an amount of from about 5 wt. % to about 35 wt. %, or from about 10 wt. % to about 30 wt. %, or from about 15 wt. % to about 25 wt. %, based on the total weight of the resin system. In some embodiments, the one or more melamine compounds in the first set of compounds may include about 0.1 wt. % to about 20 wt. %, or about 1.0 wt. % to about 15 wt. %, or about 2.0 wt. % to about 5.0 wt. %, or more than 2.0 wt. % to about 5.0 wt. % of, wherein each weight percent is based on the total weight of the resin system. The total formaldehyde present in the resin system is from about 5 wt. % to about 40 wt. %, or from about 10 wt. % to about 35 wt. %, or from about 15 wt. % to about 30 wt. %, based on the total weight of the resin system.

In the second step, the first reaction product is mixed with a second set of components comprising a urea compound, a buffering and stabilizing agent. These components are all mixed and can be heated to a temperature of from about 20° C. to about 60° C., or from about 25° C. to about 55° C., or from about 30° C. to about 50° C., to form the UF or MUF resin.

Pure UF/MUF resins are typically clear or white. Sometimes there will be a yellowish tint that is due to iron contamination and oxidation of additives that go into the resin. When lignosulfonate is added to the resin, the color shift is obvious. There are different grades of lignosulfonate and their color changes depending on region, wood species, and lignin content. In each of the foregoing embodiments, the resin system comprising the one or more lignosulfonate has a color that is noticeably different than the color of pure UF/MUF resins. Preferably, within 72 hours following formation of the resin system, 1 liter of the resin system may have an orange yellow, red, tan or brown color; or wherein within 72 hours following formation of the resin system, the resin system may have a color which is in the range of 4 to 40+ using the official AIH SRM (Standard Research Method) Number Scale for the color of beer.

The one or more urea compounds and optionally the one or more melamine compounds of the second set of components are present in an amount such that the UF or MUF resin has a molar ratio (MR) of total moles the one or more formaldehyde compounds to total moles of the one or more urea compounds and, if present, the one or more melamine compounds of from about 0.25:1 to about 2.50:1, or from about 0.25:1 to about 1.5:1. In some embodiments, the one or more urea compounds in the second set of compounds may be present in an amount of from about 15 wt. % to about 40 wt. %, or from about 20 wt. %, to about 37 wt. %, or from about 25 wt. % to about 35 wt. %, based on the total weight of the resin system. In some embodiments, the one or more melamine compounds in the second set of compounds may include about 0.1 wt. % to about 20 wt. %, or about 1.0 wt. % to about 15 wt. %, or about 2.0 wt. % to about 5.0 wt. %, or more than 2.0 wt. % to about 5.0 wt. % of, wherein each weight percent is based on the total weight of the resin system.

The purpose of the last addition of urea, is to scavenge excess free-formaldehyde. This is advantageous as this ensures the resin system meets the standard requirements for formaldehyde emissions. In some embodiments, during the second step, the one or more urea compounds, and if present, the one or more melamine compounds of the second set of components is allowed to dissolve, for about 5 minutes to about 1 hour, or about 30 minutes. Once the one or more urea compounds and, if present, the one or more melamine compounds is dissolved, the buffering and stabilizing agent may be added to the UF or MUF resin. The buffering and stabilizing agent may each independently be present in an amount of from about 0.0 wt. % to about 20 wt. %, or from about 0.001 wt. % to about 3 wt. %, or from about 0.01 wt. % to about 2.0 wt. %, based on a total weight of the resin system.

Following this, an alkaline compound or acidic compound may be added to the UF or MUF resin and mixed to adjust the pH of the resin. Preferably, the alkaline compound or acidic compound is added until a pH of about 6.5 to about 10.0, or from about 8.0 to about 10.0, or from about 8.0 to about 9.0 is achieved.

The alkaline compound may be a strong base. The incorporation of the alkaline compounds assists in the overall stability of the resin, as the same resin system devoid of the alkaline compound results in gelling. As more alkaline compound is added, the pH increases, and thus, produces a more stable resin system.

The % non-volatiles in the resin system can range from about 40 to about 80, or about 50 to about 75 as measured via NATM-A12.

The one or more urea compounds that can be used in the first or second set of components include but are not limited to dimethylol urea, methylated dimethylol urea, urea-resorcinol, and mixtures thereof.

The one or more formaldehyde compound that can be used in the first set of components include, but are not limited to formaldehyde, paraformaldehyde, trioxane, acetaldehyde, glyoxal, glutaraldehyde, polyoxymethylene, propionaldehyde, isobutyraldehyde, benzaldehyde, acrolein, crotonaldehyde, furfural, 5-hydromethylfural and combinations thereof. Formaldehyde is the most commonly used. As the aldehyde, formalin in the form of an aqueous solution is optimal, but forms, such as paraformaldehyde, benzaldehyde, trioxane, and tetraoxane can be used. It can be used by replacing with aldehyde or furfuryl alcohol.

The one or more melamine compound which is optionally used in the first and/or second set of components include, but are not limited to melamine, methylol melamine, methylated methylol melamine, imino melamine and mixtures thereof. In some embodiments, the one or more melamine compounds can be added in up to a 1:1 molar ratio with the total moles of the one or more urea compounds in the resin system, or the one or more melamine compounds can be added in 0.001:1 to a 0.5:1 molar ratio with the total moles of the one or more urea compounds in the resin system, or the one or more melamine compounds can be added in a 0.01:1 to 0.25:1 molar ratio with the total moles of the one or more urea compounds in the resin system.

The alkaline compounds may include, but are not limited to, one or more Group I or II metal hydroxides, one or more Group I or II metal carbonates, ammonia, one or more amines, or mixtures thereof. Suitable hydroxides may include, but are not limited to, sodium hydroxide, potassium hydroxide, ammonium hydroxide, (e.g. aqueous ammonia), lithium hydroxide, cesium hydroxide, or any mixture thereof. Illustrative carbonate, lithium carbonate, ammonium carbonate, or any mixture thereof. Illustrative amines can include, but are not limited to, trimethylamine, triethylamine, triethanolamine, diisopropylethylamine (Hunig's base), pyridine, 4-dimethylaminopyridine (DMAP), 1,4-diazabicyclo[2.2.2]octane (DABCO), or any mixture thereof. Preferably, the alkaline compound may be selected from sodium hydroxide, potassium hydroxide, caustic soda, ammonium hydroxide, or any mixtures thereof. Immediately following the formation of the UF or MUF resin the alkaline compound is mixed with the UF or MUF resin to form the resin system.

As discussed above, an amount of alkaline compound may be added to the first set of components to ensure the pH is within a range of 4-10, or an alkaline compound may be added to the second set of components to ensure the pH is within a range of 6.5 to about 10.0, or from about 8.0 to about 10.0, or from about 8.0 to about 9.0 when forming the resin system to secure stability and buffer capacity. Nevertheless, after a certain duration of time after the formation of the resin system, an additional amount of alkaline compound may optionally be added to improve the stability. The duration of time may be from about 1 to about 72 hours, or from about 2 hours to about 60 hours, or about 24 to 48 hours after the formation of the resin system. The amount of the alkaline compound which may be added to the resin system until a pH of from about 6.5 to about 10.0, or from about 8.0 to about 10.0, or from about 8.0 to about 9.0 is achieved.

The acidic compounds may include, but are not limited to, chloric acid, hydrobromic acid, hydrochloric acid, hydroiodic acid, nitric acid, perchloric acid, sulfuric acid, sulfurous acid, phosphoric acid, acetic acid, formic acid, benzoic acid, oxalic acid, hydrogen sulfate ion, nitrous acid, hydrofluoric acid, carbonic acid, methanoic acid or any mixtures thereof.

As discussed above, an amount of acidic compound may be added to the second set of components to ensure the pH is within a range of 6.5 to about 10.0, or from about 8.0 to about 10.0, or from about 8.0 to about 9.0 when forming the resin system to secure stability and buffer capacity.

The UF resin further comprises a lignosulfonate which may be included in either the first set of components or with the second set of components, in an amount of from about 0.1 wt. % to about 30 wt. %, or about 1.0 wt. % to about 15 wt. %, or about 2.0 wt. % to about 5.0 wt. %, or more than 2.0 wt. % to about 5.0 wt. %, based on the total weight of the resin system.

In embodiments where the lignosulfonate is included in the first set of components, the lignosulfonate, the one or more urea compounds, total formaldehyde and if present, the one or more melamine compounds of the first set of components, are mixed and heated together. In embodiments where the lignosulfonate is included in the second set of components, the lignosulfonate is added after the one or more urea compounds, and if present, the one or more melamine compounds of the second set of components is dissolved and the buffering and stabilizing agent is added but prior to the addition of the alkaline compound.

Lignosulfonate may be extracted, separated, or otherwise recovered from wood, plant, and/or vegetable matter using any of a number of well-established processes. For example, in the pulp and paper industry, lignin-containing materials such as wood, straw, corn stalks, bagasse, and other vegetable and plant tissues can be processed to recover the cellulose pulp via the known sulfite process. The residual pulping liquors that include the lignin as a byproduct can be a source of lignin. The chemical structure of lignin can vary, and the variation can depend, at least in part, on the particular plant from which the lignin is recovered from, location the plant was grown, and/or on the particular method used in recovery or isolation of the lignin from the plant and/or vegetable matter. Lignin can include active groups, such as active hydrogens and/or phenolic hydroxyl groups through which crosslinking or bridging can be effected.

One process for recovering lignin can include the process commonly referred to as the organosolv process. The organosolv process uses an organic solvent to solubilize lignin and hemicelluloses. The organosolv process can include contacting lignocellulose material, e.g., wood chips or particles, with an aqueous organic solvent at a temperature of about 130° C., about 140° C., or about 150° C. to about 200° C., about 220° C., or about 230° C. The lignin can break down by hydrolytic cleavage of alpha aryl-ether links into fragments that can be solubilized in the solvent system. Illustrative solvents can include, but are not limited to, acetone, methanol, ethanol, butanol, ethylene glycol, formic acid, acetic acid, or any mixture thereof. The aqueous organic solvent can have a concentration of the solvent in water of about 30 wt %, about 40 wt % or about 50 wt % to about 70 wt %, about 80 wt %, or about 90 wt %.

Since the lignin separated from the plant can be chemically altered from that found in the plant, the term “lignin,” can also refer to lignin products obtained upon separation from the cellulose or recovered from the plant matter. For example, in a sulfite pulping process, the lignocellulose material can be digested with a bisulfite or sulfite resulting in the at least partial sulfonation of the lignin. As such, the lignin can optionally be subjected to further cleavage and/or other modifications such as alkaline treatment or reaction with other constituents to decrease the sulfonate or sulfur content and/or increase the active groups.

The liquors form which the lignin can be recovered can also include one or more other constituents in addition to the lignin. For example, in the sulfite pulping process, the spent sulfite liquor can include lignosulfonates that can be present as salts of cations, such as magnesium, calcium, ammonium, sodium, potassium and/or other cations. The spent sulfite liquor solids can include about 40 wt. % to about 65 wt. % lignosulfonates with the remainder being carbohydrates and other organic and inorganic constituents dissolved in the liquor.

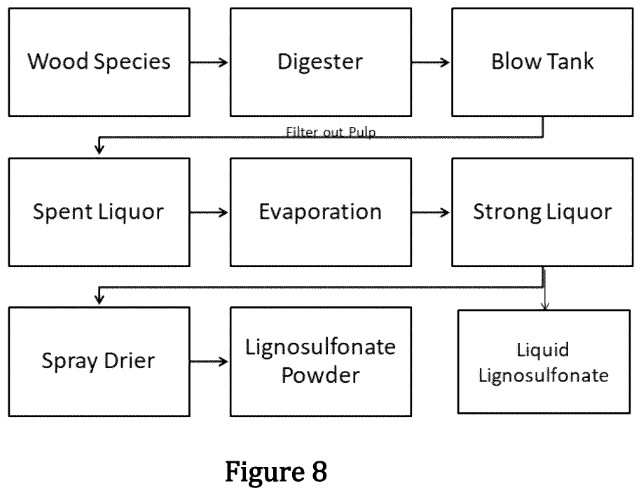

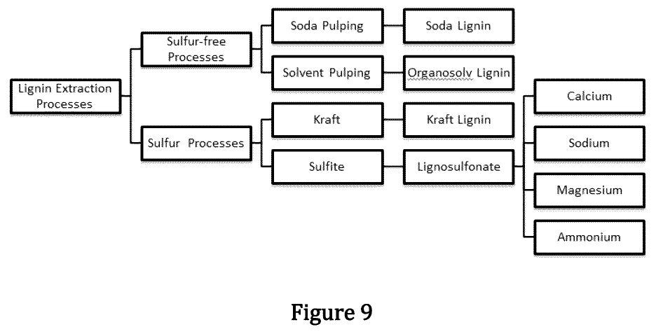

Preferably, the lignin employed in the present invention is prepared from the sulfite pulping process to produce a lignosulfonate. This process is illustrated in FIG. 8. Preferably, the resin systems do not include lignin species, such as kraft lignin. FIG. 9 demonstrates the differences in the pulping process for preparing lignosulfonates compared to lignin species.

Suitable examples of lignosulfonates may be selected from calcium lignosulfonate, magnesium lignosulfonate, ammonium lignosulfonate, or sodium lignosulfonate, or preferably, ammonium lignosulfonate or sodium lignosulfonate. The lignosulfonates of the resin system may have a weight average molecular weight of from about 1,000 daltons to about 100,000 daltons, as measured by gel permeation chromatograph (“GPC”). For example, the lignosulfonate may have a weight average molecular weight of from about 5,000 daltons to about 80,000 daltons, or from about 15,000 to about 80,000 daltons, or from about 30,000 to about 70,000 daltons, or from about 50,000 to about 70,000 daltons, as measured by gel permeation chromatograph (“GPC”). The lignosulfonates of the resin system may have a number average molecular weight of from about 50 daltons to about 25,000 daltons, or from about 5,000 daltons to about 25,000 daltons, or from about 12,000 daltons to about 20,000 daltons, as measured by gel permeation chromatograph (“GPC”). The lignosulfonates of the resin system may have a polydispersity (Mw/Mn) of from about 1 to about 100, or from greater than 1 to about 20, or from about 2 to 8. Preferably, lignin species, such as kraft lignin is not added to the resin system.

The lignosulfonates of the present invention may include from about 1 wt. % to about 20 wt. % sulfur, or from about 1.5 wt. % to about 15 wt. % sulfur, or from about 3 wt. % to about 10 wt. % sulfur, based on the weight of the lignosulfonate.

The buffering and stabilizing agent may be employed to stabilize the pH of a solution, i.e. resist changes in pH when acidic or alkaline materials are added to a solution. Suitable buffering and stabilizing agents may be selected from glycine hydrochloride, sodium acetate, phosphate buffered saline (PBS) (including mono-and dihydrogen phosphate slats), citrate buffer (citric acid and sodium citrate), phosphate-citrate buffer, tris(hydroxymethyl)aminomethane (tris), carbonate buffers, borate buffers, borate buffered saline, magnesium chloride, potassium chloride, zinc chloride, hydrochloric acid, sodium hydroxide, edetate disodium, various substituted amines (alkyl amines, aliphatic and aromatic diamines and triamines) and their salts, sodium formate, sodium sulfate, phosphate salts (potassium mono- , di- and tri-basic), and combinations thereof.

The buffering and stabilizing agent can be present in an amount from 0.001 wt. % to 20 wt. %, or 0.001 wt. % to 2 wt. %, or 0.01 wt. % to 1.0 wt. %, based on the total weight of the resin system.

The UF or MUF resin, excluding the lignosulfonate, may have a number average molecular weight (Mn) of from about 300 daltons to about 20,000 daltons, or from about 1,000 daltons to 10,000 daltons, or from about 1,500 daltons to about 9,000 daltons, as measured by gel permeation chromatograph (“GPC”). The UF or MUF resin, excluding the lignosulfonate, may have a weight average molecular weight of from about 30,000 to about 200,000 daltons, as measured by gel permeation chromatograph (“GPC”). The UF or MUF resin, excluding the lignosulfonate, may have a polydispersity (Mw/Mn) of from about 10 to about 100.

The resin system of the present invention has a suitable buffer capacity of 2-400 mL, or greater than 5 to 150 mL, preferably 20-60 mL of 0.1 N HCl by the ATV Method for a period of time of at least about 20 days at 25° C. Well known MUF resin systems cannot be simply modified to replace some or all of the melamine with lignosulfonate to achieve compositions that are of the same quality, thus other components, such as a buffering and stabilizing agent and alkaline compound are preferred. These components ensure that the resin system achieve the appropriate buffer capacity. Too low of a buffer capacity results in an unstable material that will cure to early and dry out, but too high of a buffer capacity cures too slowly in the press, losing efficacy of the material.

The viscosity of the resin system may widely vary depending on the amount of time which has passed from the time of manufacture. For example, the kinematic viscosity of the resin system may range from about 100 to about 1,500 cSt, or about 100 to about 1,000 cSt, or about 100 to about 600 cSt at a temperature of about 25° C., as measured by the Gardner-Holdt viscosity method, for a period of time of at least about 20 days at 25° C., and wherein the period of time starts when the resin system is initially produced, and the resin system has may have a fast cure rate so to achieve an improvement in internal bond strength when compared to the Control resin system of up to 20%, preferably 10% to 20% at <7.0 press factor at 350° F. platen temperature. When measured at full cure at <7.0 press factor at 350° F. platen temperature, the IB is at least as good for the inventive resin as compared to the comparative resin. The control resin is Comparative Example B, discussed below.

The Gardner-Holdt (Bubble) viscosity method allows for quick determination of the kinematic viscosity of liquids such as resins and varnishes. Certified tubes from Gardner may be used for the measurement of the viscosity at room temperature, approximately 25° C. The Gardner-Holdt (Bubble) viscosity method may include a scale which ranges from A4-Z6 which corresponds to a range of kinematic viscosity of 10 cSt to approximately 15,000 cSt, at 25° C., as measured by a Brookfield viscometer with a small sample adapter such as a 10 mL adapter and the appropriate spindle to maximize torque such as a spindle no. 31. Suitable values for the viscosity of the resin system may include D-U, or preferably, H-S, via the Gardner-Holdt scale. Table 1 shows the Gardner-Holdt (Bubble) viscosity scale with their corresponding kinematic viscosities, as measured by a Brookfield viscometer with a 10 mL adapter and spindle no. 31:

TABLE 1

| cSt @ | Gardner- |
|---|---|
| 25° C. | Holdt scale |
| 100 | D |
| 120 | E |
| 140 | F |
| 160 | G |
| 200 | H |
| 220 | I |
| 240 | J |
| 280 | K |
| 300 | L |
| 320 | M |
| 340 | N |
| 360 | O |
| 400 | P |
| 440 | Q |
| 460 | R |
| 500 | S |
| 550 | T |
| 600 | U |

The resin system may also optionally include an amount of melamine. The melamine may be present in an amount of from about 0.0 wt. % to about 30 wt. % or from about 0.0 wt. % to about 25 wt. %, or from about 0.0 wt. % to about 20 wt. % or from about 0.1 wt. % to about 15 wt. %, based on the total weight of the resin system. In some embodiments, no melamine is added to the resin composition.

In some embodiments, the UF or MUF resin may optionally be prepared with water. The water may be present in the resin system in an amount to provide from about 0.0 wt. % to about 40 wt. %, or from about 0.0 wt. % to about 9 wt. %, or from about 0.01 wt. % to about 2 wt. %, based on the total weight of the resin system. In embodiments where water is present, the water is included with either the first set of components or with the second set of components. The resin systems as disclosed herein employ low levels of water compared to well-known urea-formaldehyde resins in the art. Typically, water is included to reduce the viscosity of a resin system and to help with heat transfer from the surface of the product during the curing step. However, the combination of components in certain ratios of the present disclosure allows for resin systems capable of achieving a suitable viscosity, without the addition of large quantities of water.

The resin system may optionally include additional additives, such as primary, secondary, and tertiary amines, for example, triethanolamine, organic and inorganic salts, and metal hydroxides.

The resin systems discussed above may be used as adhesives, which then, may be used to make composite products. For example, the present invention may also relate to blended furnishes including a plurality of granulated, or fibrous lignocellulose substrates and an adhesive comprising the resins systems.

The adhesives of the present invention may include additional components, such as fillers, extenders, organic and inorganic salts, organic polyols and carbohydrate-based additives, acrylics, and organic proteins.

Suitable fillers can include, but are not limited to, nut shell media, corn media or corn cob media, furfural residues, or any mixture thereof. The nut shell media can be or include whole, broken, chopped, crushed, milled, and/or group shells from one or more nuts and/or seeds. Suitable net shell media can include, but is not limited to, almond, walnut, pecan, chestnut, hickory, cashew, peanut, macadamia, or any mixture thereof. The corn media can be or include broken, chopped, crushed, or ground corn cobs, corn stalks, or other corn derived products, or any mixture thereof. Corn media can also include furfural residue from corn cobs, corn stalks, or other corn derived products. An illustrative corn derived produce can include, but is not limited to, a cellulose byproduct derived from the manufacture of furfural, or furfural residues, including floral and furfural-derived compounds, can also come from oat, wheat, wheat bran, barely, wood particles, sawdust, and/or other plant-based products. Illustrative seed shells (including fruit pits), can include, but are not limited to, the seed shells or pits of fruit, e.g. plum, peach, cherry, apricot, olive, mango, olive, jackfruit, guava, custard apples, pomegranates, pumpkins, watermelon, ground or crushed seed shells of other plants such as maize, wheat, rice jowar, sunflowers, or the like, or any mixture thereof. Other examples of suitable fillers include, but are not limited to, wheat shell, corn husk, peanut shell, or any combination thereof.

Suitable extenders can include, but are not limited to, one or more flours, one or more polysaccharides, one or more starches, one or more polysaccharide starches, or any mixture thereof. Flours can be ground or milled to a variety of different granular sizes, such as fine, ultra-fine, or very ultra-fine granular sizes. Illustrative flours can include, but are not limited to, wheat flour, corn flour, soy flour, oat flour, other grain flours, nut or seed flour (e.g., almond, walnut, pecan, cashew, or peanut), brands thereof, starches thereof, or any mixture thereof. In some examples, the extender can be or include corn flours or corn starches, such as NCS-83, NCS-74, and 4501 flours, commercially available from Didion Milling Company, Inc., Sun Prairie, WI. In other examples, the extender can be or include wheat flours, wheat starches, and/or wheat derived protein-starch composition. Illustrative polysaccharides can include, but are not limited to, starch, cellulose, gums, such as guar and xanthan, alginates, pectin, gellan, or any mixture thereof. Suitable polysaccharide starches can include, for example maize or corn, native corn starch (NCS), waxy maize, high amylose maize, potato, tapioca, wheat starch, or any mixture thereof. Other starches, such as genetically engineered starches, can include high amylose potato starches, potato amylopectin starches, or any mixture thereof.

In one or more embodiments, the method for making a composite lignocellulosic product can include contacting a plurality of lignocellulose substrates and a partially cured resin system, as disclosed above. The resin system can be at least partially cured, e.g. by heating, to produce the composite product. The composite lignocellulosic product can also include, but is not limited to, the extender, the filler, or any mixture thereof.

Heating the resin system can cause or promote the at least partial curing the of the resin system to produce the composite product. As used herein, the terms “curing”, “cured,” “at least partially curing,” “at least partially cured’, and similar terms are intended to refer to the structural and/or morphological change that occurs in the mixture, such as by covalent chemical reaction (crosslinking), ionic interaction or clustering, phase transformation or inversion, and/or hydrogen bonding when it is subjected to conditions sufficient, i.e. sufficiently heated, to cause the properties of a flexible, porous substrate, such as a nonwoven mat or blanket of lignocellulose substrates, and/or rigid or semi-rigid substrate, such as a wood or other lignocellulose containing board or sheet, to which an effective amount of the adhesive has been applied, to be altered.

In one or more embodiments, one or more additives can be combined with the adhesive and/or any one or more components of the adhesive to produce the composite product.

Illustrative additives can include, but are not limited to, waxes and/or other hydrophobic additives, release agents, dyes, fire retardants, formaldehyde scavengers, biocides, or any mixture thereof. In some examples, the mixtures, compositions, and products, including, but not limited to, the adhesive, the composite product, can be produced by a process for homogenizing, agitating, mixing, blending, or otherwise combining process, such as with homogenization, ultrasonication, colloid milling, microfluidic mixing as a method of homogenization, or other similar processes.

Illustrative composite products can include, but are not limited to, plywood (e.g., hardwood plywood and/or softwood plywood), oriented strand board (“OSB”), laminated veneer lumber (“LVL”), laminated veneer boards (“LVB”), engineered wood flooring, particleboard (“PB”), fiberboard (e.g., medium density fiberboard (“MDF”) and/or high density fiberboard (“HDF”)), or other wood and non-wood products, preferably, the composite product is a particleboard or medium density fiberboard.

Illustrative products are not necessarily primarily wood based and can include composites comprising the inventive resin system and glass mat and/or abrasives. The inventive resin system can be used in glass fiber nonwoven systems or as an impregnation resin in one or more layers of an overlay.

In some examples, the method can also include applying the adhesive between two or more wood veneers or wood sheets to produce the composite product (e.g., plywood, OSB, LVL, LVB, or engineered wood flooring). The plurality of lignocellulose substrates can be or include wood veneers or wood sheets and the adhesive can be disposed between wood veneers or wood sheets. In other examples, the method can also include forming a lignocellulose adhesive mixture or “resinated furnish” by combining the plurality of lignocellulose substrates and the adhesive and heating the adhesive to produce the composite product (e.g., particleboard, MDF, or HDF).

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure. All patents and publications cited herein are fully incorporated by reference herein in their entirety.

To demonstrate if replacing melamine with an ecofriendly lignosulfonate in melamine-urea-formaldehyde resin provides comparable properties, five different resin systems are tested for internal bond strength, pH stability, and buffer capacity.

### Inventive Example 1: UF Resin With Lignosulfonate (Post-Add)

In a vessel, a first set of components are mixed. 40-50 parts formaldehyde (52.5% solution) are combined with 0.01-0.1 parts of triethanolamine, and 0.5-1.5 parts water. The temperature is maintained within 50°° C. to 80° C. and the pH is maintained between 8-10 with acid or base as necessary. 20-30 parts of urea are added and the temperature is increased within 80° C. to 110° C. and the pH is maintained between 4-8 with acid or base as necessary. The second set of components are then added. The temperature is decreased to be within 40°° C. to 80° C. and 25-50 parts of urea, 1.0-5.0 parts of a first lignosulfonate salt and 0.01-0.1 parts of one or more buffering and stabilizing agents are mixed in. The final pH is maintained between 8-10 with acid or base as necessary.

### Inventive Example 2: UF Resin With Lignosulfonate (Post-Add)

The process described above for Inventive Example 1 is essentially repeated except that a different lignosulfonate salt is used.

### Inventive Example 3: UF Resin With Lignosulfonate (Up Front)

In a vessel, a first set of components are mixed. 40-50 parts formaldehyde (52.5% solution) are combined with 0.01-0.1 parts of triethanolamine, 0.5-1.5 part water and 1-5 parts of the same lignosulfonate salt used in Inventive Example 2. The temperature is maintained within 50°° C. to 80° C. and the pH is maintained between 8-10 with acid or base as necessary. 20-30 parts of urea are added and the temperature is increased within 80° C. to 110° C. and the pH is maintained between 4-8 with acid or base as necessary. The second set of components are then added. The temperature is decreased to be within 40° C. to 80° C. and 25-50 parts of urea and 0.01-0.1 parts of one or more buffering and stabilizing agents are mixed in. The final pH is maintained between 8-10 with acid or base as necessary.

### Inventive Example 4: MUF Resin With Lignosulfonate (Up Front)

In a vessel, a first set of components are mixed. 40-50 parts formaldehyde (52.5% solution) are combined with 0.01-0.1 parts of triethanolamine, 0.5-1.5 part water, 1-5 parts of melamine and 1-5 parts of lignosulfonate salt. The temperature is maintained within 50° C. to 80° C. and the pH is maintained between 8-10 with acid or base as necessary. 20-30 parts of urea are added and the temperature is increased within 80°° C. to 110° C. and the pH is maintained between 4-8 with acid or base as necessary. The second set of components are then added. The temperature is decreased to be within 40°° C. to 80° C. and 25-50 parts of urea and 0.01-0.1 parts of one or more buffering and stabilizing agents are mixed in. The final pH is maintained between 8-10 with acid or base as necessary.

### Comparative Example A: MUF Resin Without Lignosulfonate

The process described above for Inventive Example 3 is essentially repeated except that the 1-5 parts of lignosulfonate is replaced with 1-5 parts of melamine. In this Comparative Example A, no lignosulfonate is used.

### Comparative Example B: UF Resin Without Melamine or Lignosulfonate

The process described above for Inventive Example 2 is essentially repeated except that no lignosulfonate is used. In this Comparative Example B, no lignosulfonate or melamine is used.

### Inventive Example 5: MUF Resin With Modified Sulfonated Kraft Lignin (Post-Add)

In a vessel, 53.7 grams of water was mixed with 33.1 grams of Kraft Lignin. pH was adjusted to 10-12 pH with 50% Sodium Hydroxide before heating to 90° C. 5.2 grams of Sodium Metabisulfite was added to the vessel and mixed for 15 minutes before heating to 100° C. The vessel was held at 100° C. for 6 hours at a pH of 9.1. The vessel was then cooled to 40° C. and adjusted to a pH of 13-14 with 50% Sodium Hydroxide to obtain the modified sulfonated Kraft Lignin.

In a vessel, a first set of components are mixed. 40-50 parts formaldehyde (52.5% solution) are combined with 0.01-0.1 parts of triethanolamine, 0.5-1.5 parts water, and 1-5 parts Melamine. The temperature is maintained within 50° C. to 80° C. and the pH is maintained between 8-10 with acid or base as necessary. 20-30 parts of urea are added and the temperature is increased within 80° C. to 110° C. and the pH is maintained between 4-8 with acid or base as necessary. The second set of components are then added. The temperature is decreased to be within 40° C. to 80° C. and 25-50 parts of urea, 1.0-5.0 parts of the modified sulfonated lignin and 0.01-0.1 parts of one or more buffering and stabilizing agents are mixed in. The final pH is maintained between 8-10 with acid or base as necessary.

### Inventive Example 6: MUF Resin With Modified Sulfonated Kraft Lignin and Cellulose (Post-Add)

The process described above for Inventive Example 5 is essentially repeated except that 1-5 parts methyl cellulose is added with the modified sulfonated kraft lignin.

### Inventive Example 7: MUF Resin With Modified Lignosulfonate (Post-Add)

In a vessel, 243 grams of Choline Chloride was mixed with 209 grams of Urea and heated to 60° C. to obtain a quaternary ammonium salt. 50 grams of lignosulfonate salt was added to the vessel and held at 80° C. for 1 hour to obtain the modified lignosulfonate.

In a vessel, a first set of components are mixed. 40-50 parts formaldehyde (52.5% solution) are combined with 0.01-0.1 parts of triethanolamine, 0.5-1.5 parts water, and 1-5 parts Melamine. The temperature is maintained within 50°° C. to 80° C. and the pH is maintained between 8-10 with acid or base as necessary. 20-30 parts of urea are added and the temperature is increased within 80° C. to 110° C. and the pH is maintained between 4-8 with acid or base as necessary. The second set of components are then added. The temperature is decreased to be within 40° C. to 80° C. and 25-50 parts of urea, 1.0-5.0 parts of the modified lignosulfonate and 0.01-0.1 parts of one or more buffering and stabilizing agents are mixed in. The final pH is maintained between 8-10 with acid or base as necessary.

### Inventive Example 8: MUIF Resin With Modified Lignosulfonate (Post-Add)

In a vessel, 136 grams of Choline Chloride was mixed with 284 grams of Glyoxal and heated to 60° C. to obtain a quaternary ammonium salt. 28 grams of lignosulfonate salt was added to the vessel and held at 100° C. for 1 hour to obtain the modified lignosulfonate.

In a vessel, a first set of components are mixed. 40-50 parts formaldehyde (52.5% solution) are combined with 0.01-0.1 parts of triethanolamine, 0.5-1.5 parts water, and 1-5 parts Melamine. The temperature is maintained within 50° C. to 80° C. and the pH is maintained between 8-10 with acid or base as necessary. 20-30 parts of urea are added and the temperature is increased within 80° C. to 110° C. and the pH is maintained between 4-8 with acid or base as necessary. The second set of components are then added. The temperature is decreased to be within 40° C. to 80° C. and 25-50 parts of urea, 1.0-5.0 parts of the modified lignosulfonate and 0.01-0.1 parts of one or more buffering and stabilizing agents are mixed in. The final pH is maintained between 8-10 with acid or base as necessary.

### Inventive Example 9: MUF Resin With Modified Lignosulfonate (Post-Add)

In a vessel, 132.9 grams of Zinc Chloride was mixed with 293.9 grams of Urea and heated to 60° C. to obtain a quaternary ammonium salt. 34 grams of lignosulfonate salt was added to the vessel and held at 100° C. for 1 hour to obtain the modified lignosulfonate.

In a vessel, a first set of components are mixed. 40-50 parts formaldehyde (52.5% solution) are combined with 0.01-0.1 parts of triethanolamine, 0.5-1.5 parts water, and 1-5 parts Melamine. The temperature is maintained within 50° C. to 80° C. and the pH is maintained between 8-10 with acid or base as necessary. 20-30 parts of urea are added and the temperature is increased within 80° C. to 110° C. and the pH is maintained between 4-8 with acid or base as necessary. The second set of components are then added. The temperature is decreased to be within 40° C. to 80° C. and 25-50 parts of urea, 1.0-5.0 parts of the modified lignosulfonate and 0.01-0.1 parts of one or more buffering and stabilizing agents are mixed in. The final pH is maintained between 8-10 with acid or base as necessary.

### Lignin Sulfonation

### Inventive Example 10

Water (559.6 g) and aqueous sodium hydroxide (50% solution, 58.7 g) are added to a pressure-resistant vessel equipped with an agitator. Commercial Softwood Kraft Lignin (Domtar, 72.8% solids, 300 g on a dry basis) is added to the vessel. Stirring is started, and the resulting suspension (32% solids, pH 10.4) is brought to a temperature of 90° C. and stirred for 30 minutes. Sodium sulfite (73.5 g or 0.35 equivalent versus lignin on a sulfite ion basis, assuming a 180 g/mol for the lignin monomeric subunits) is added to the reaction vessel, followed by a closure and sealing of the vessel. The reaction mixture is brought to a sulfonation temperature of 120° C. (35.3% solids, pH 10.8) and maintained at 120° C. for 10 hours to provide a sulfonated lignin mixture. The sulfonated lignin mixture is then cooled to a temperature of 40° C.

### Inventive Example 11

Water (507.7 g) and aqueous sodium hydroxide (50% solution, 74.0 g) are added to a pressure-resistant vessel equipped with an agitator. Commercial Softwood Kraft Lignin (West Fraser-Type A, 60.4% solids, 260 g on a dry basis) is added to the vessel. Stirring is started, and the resulting suspension (29% solids, pH 11.5) is brought to a temperature of 85° C. and stirred for one hour. Sodium metabisulfite (54.9 g or 0.4 equivalent versus lignin on a sulfite ion basis, assuming a 180 g/mol for the lignin monomeric subunits) is added to the reaction vessel, followed by a closure and sealing of the vessel. The reaction mixture is brought to a sulfonation temperature of 150° C. (31.6% solids, pH 10.0) and maintained at 150° C. for 6 hours to provide a sulfonated lignin mixture. The sulfonated lignin mixture is then cooled to a temperature of 40° C.

### Inventive Example 12

The sulfonated lignin mixture from Example 11 is alternatively cooled to a temperature of 40° C. and the solution adjusted to pH 11.0 using aqueous sodium hydroxide.

### Inventive Example 13

Water (591.1 g) and aqueous sodium hydroxide (50% solution, 27.6 g) are added to a pressure-resistant vessel equipped with an agitator. Commercial Softwood Kraft Lignin (West Fraser-Type B, 70.5% solids, 270 g on a dry basis) is added to the vessel. Stirring is started, and the resulting suspension (28% solids, pH 11.4) is brought to a temperature of 85° C. and stirred for 30 minutes. At this point, sodium metabisulfite (28.5 g or 0.2 equivalent versus lignin on a sulfite ion basis, assuming a 180 g/mol for the lignin monomeric subunits) is added to the reaction vessel, followed by a closure and sealing of the vessel. The reaction mixture is brought to a sulfonation temperature of 110° C. (30% solids, pH 9.7) and maintained at 110° C. for 9 hours to provide a sulfonated lignin mixture. The sulfonated lignin mixture is then cooled to a temperature of 40° C.

### Inventive Example 14

Softwood Kraft Lignin (Lignoforce™ Resolute Lignin, 53.8% solids, 130 g on a dry basis) is added to a reaction vessel equipped with a condenser and mechanical agitator. Water (211.1 g) is added under constant stirring. To the resulting suspension, aqueous sodium hydroxide (50% solution, 31.2 g) is added. The suspension (32% solids, pH 11.3) is brought to a temperature of 90° C., at which point sodium metabisulfite (20.6 g or 0.30 equivalent versus lignin on a sulfite ion basis, assuming a 180 g/mol for the lignin monomeric subunits) is added to the reaction vessel. After 15 minutes of stirring, the reaction is brought to reflux at 100° C. (32% solids, pH 9.1) and maintained at 100° C. for 12 hours to provide a sulfonated lignin mixture. The mixture is then cooled to a temperature of 40° C. and the solution adjusted to pH 13.5 using aqueous sodium hydroxide (50%).

### Inventive Example 15

Commercial Softwood Kraft Lignin (West Fraser—Type A, 60.4% solids, 90 g on a dry basis) is added to a reaction vessel equipped with a condenser and mechanical agitator. Water (187.9 g) is added under constant stirring. To the resulting suspension, aqueous potassium hydroxide (37% solution, 49.5 g) is added. The suspension (28% solids, pH 11.5) is brought to a temperature of 85° C., at which point sodium metabisulfite (16.6 g or 0.35 equivalent versus lignin on a sulfite ion basis, assuming a 180 g/mol for the lignin monomeric subunits) is added to the reaction vessel. After 15 minutes of stirring, the reaction is brought to reflux at 100° C. (29.5% solids, pH 10.2) and maintained at 100° C. for 12 hours to provide a sulfonated lignin mixture. The sulfonated lignin mixture is then cooled to a temperature of 40° C.

Samples were tested and the following results were obtained.

TABLE 2

| | Com- | Com- | Inventive | Inventive | Inventive |
|---|---|---|---|---|---|
| | parative | parative | Example | Example | Example |
| | Example A | Example B | 1 | 2 | 3 |
| Refractive Index | 1.4697 | 1.4671 | 1.4699 | 1.4701 | 1.4685 |
| % Non-Volatiles | 64.3 | 63.8 | 64.7 | 65.0 | 64.2 |
| Final pH | 8.53 | 8.59 | 8.69 | 8.91 | 8.34 |
| Kinematic | 198 | 211 | 294 | 274 | 233 |
| Viscosity (cSt) | | | | | |
| Buffer Capacity | 19.2 | 10.5 | 18.8 | 15.0 | 14.1 |
| (mL 0.1N HCl) | | | | | |
| Appearance | Clear | Clear | Dark | Dark | Dark |
| | | | Red- | Red- | Red- |
| | | | Brown | Brown | Brown |
| Color (AIH SRM) | N/A | N/A | 32 | 31 | 31 |

TABLE 3

| | Inventive | Inventive | Inventive | Inventive |
|---|---|---|---|---|
| | Example | Example | Example | Example |
| | 5 | 7 | 8 | 9 |
| %Non-Volatiles | 62.5 | 64.6 | 63.9 | 63.2 |
| Final pH | 8.91 | 8.47 | 8.44 | 8.42 |
| Kinematic | 165 | 244 | 251 | 436 |
| Viscosity (cSt) | | | | |
| Buffer Capacity | 18.4 | 20.6 | 21.2 | 22.0 |
| (mL 0.1N HCl) | | | | |
| Appearance | Dark | Dark | Orange | Dark |
| | Brown | Red | | Orange |
| Color (AIH SRM) | 39 | 23 | 9 | 12 |

The Refractive Index is measured by digital refractometer.

% Non-Volatiles is measured via NATM-A12. A liquid resin sample is cured in aluminum pan in convection oven with an airflow @ 105° C. for 3 hours.

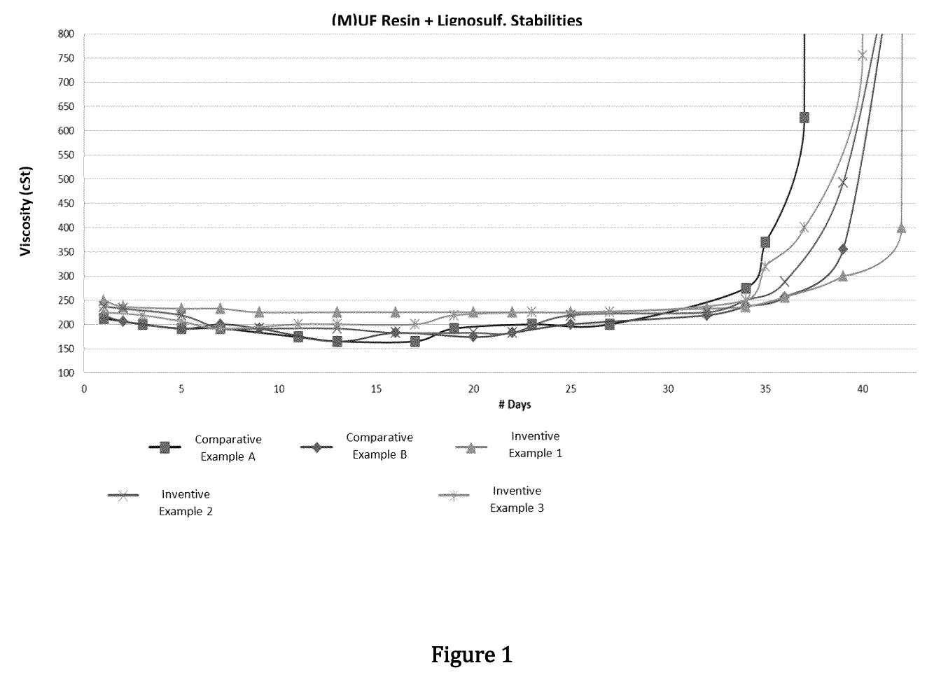

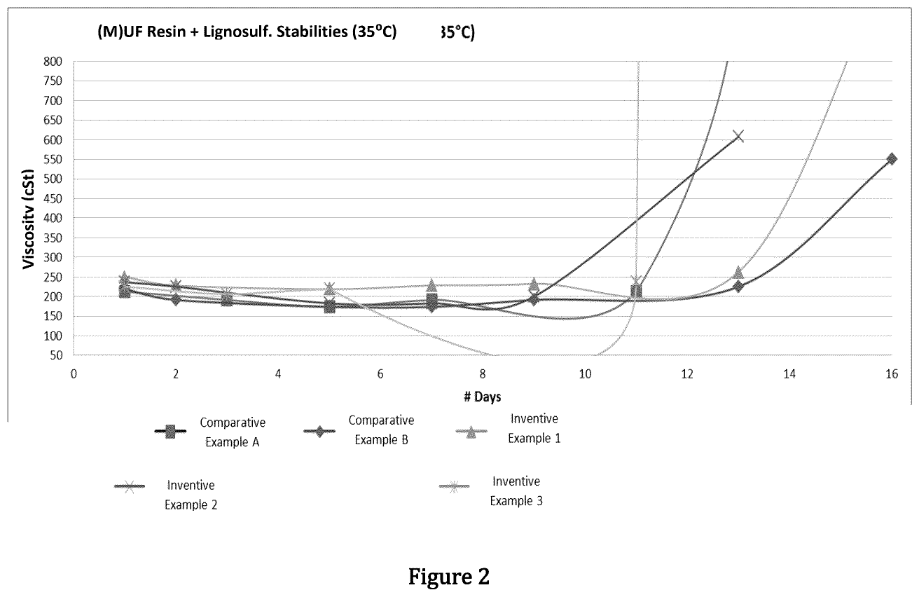

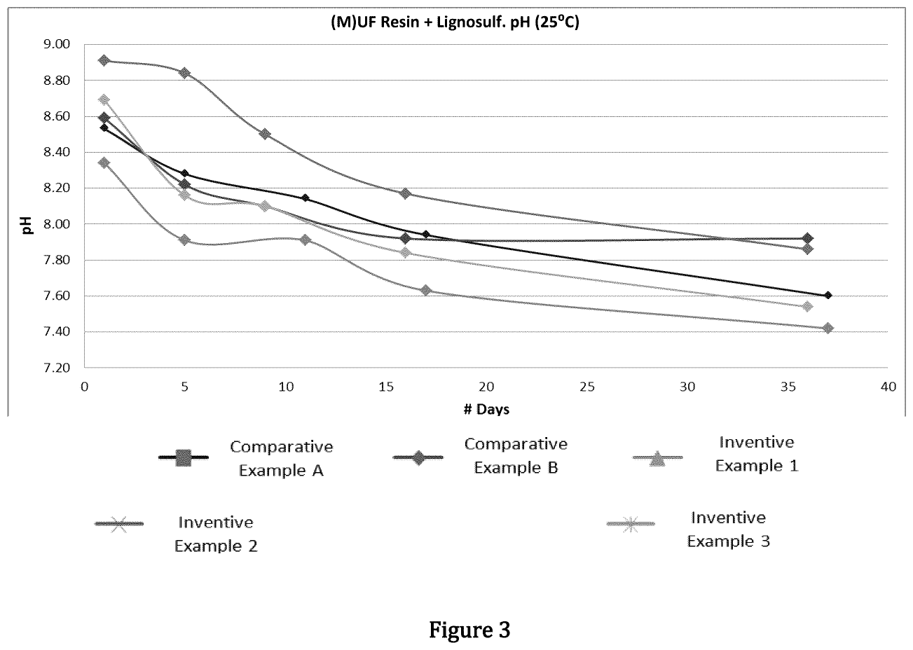

The viscosity of each resin is determined immediately after the final pH is reached using the Brookfield viscosity method (NATM-B01/ASTM-D1084), at 25° C. See Table 1. FIGS. 1 and 2 show the viscosity stability over time for Comparative Examples A and B and Inventive Examples 1-3 at 25° C. and 35° C., respectively. As seen from these charts, Inventive Examples 1, 2 and 3 comprising the lignosulfonate devoid of melamine provide similar viscosity stability when compared to Comparative Examples A and B. The viscosity of the resin system is stable so as to vary by no more than 100 cSt at 25° C. for at least 20 days, preferably at least 25 days, more preferably about 20 to 48 days. FIG. 3 shows the pH decay over time for Inventive Examples 1-3 and Comparative Examples A and B at 25° C. As seen from these results, Inventive Examples 1-3 and Comparative Examples A and B demonstrated similar pH stability. In view of the fact that the inventive resin system has viscosity stability, it can be shipped in a single container as a mixture to the customer without concern of separation of components.

To determine the buffer capacity, each of the resins were measured via Acid Titration Value (ATV). The ATV method is carried out by collecting 40.0+0.1 grams of a resin material into a beaker. 150 mL of a 50:50 mixture by volume of isopropyl alcohol:water was added to the beaker with resin and mixed. The solution was then titrated with 0.1 HCl increments. The buffer capacity was determined by the mL of 0.1 HCl required to achieve a pH of 4.0. The results are shown in Table 2 and 3.

The buffer capacity will depend on the system and can be manipulated so as not to be too high or too low to ensure a proper balance between cure speed and pre-cure dry out resistance. The buffer capacity can be tailored so as to be optimized for a particular apparatus used to incorporate the inventive resin system in the product. Buffer capacity requirements are dependent on resin stoichiometry and customer process. Both lignosulfonate and melamine content contribute to higher buffer capacity. The buffer capacity of the resin system is stable and will not go outside the range of 2-400 mL, or greater than 5 to 150 mL, preferably 20-60 mL of 0.1 N HCl by the ATV Method at 25° C. for at least 20 days, preferably at least 25 days, more preferably about 20-48 days.

To determine the color, within 72 hours following formation of the resin system, the colors of the resins were measured using the official AIH SRM (Standard Research Method) Number Scale for the color of beer.

Homogenous particleboards panels were prepared by blending each of Inventive Examples 1-3 and Comparative Examples A and B with a Douglas fir face furnished. The resins were applied via a spray gun with compressed air for atomization. Each of the panels were pressed in a single-opening laboratory pneumatic hot press at increasing press cycle times to obtain a cure curve to determine the relative cure speed and internal bond strength development.

Table 4 shows the parameters for preparing the particleboards.

TABLE 2

| Thickness | 0.570″ | Stops |
|---|---|---|
| Platen Temperature | 350° | F. |
| % Resin Loading^{a} | 10 | wt. % |
| % Scavenger | 0% | |
| % Blended Moisture | 9-10% | |
| Content Target^{b} | | |
| Actual | Avg 9.4% | |
| Density: Target | 45 | pound/ft³ |

| | |
|---|---|
| Actual | (at full cure) 43.5-44.7 pound/ft³ |
| Cycle Times | 90, 120, 150, 180, 210, 250 sec |
| Dry Out Temperatures^{c} | 140° F., 160° F., 180° F. following the |
| | Dry out protocol. All at full cure (250 s) |
| Construction | Homogenous Face Furnish (3.7-3.9% |
| | Moisture Content) |

^{a}Percent resin loading = Wt. % of resin solids/% oven dried wood
^{b}% BMC = measured % MC of Resin + substrate after blending. Target % BMC will change based on specific panel construction and customer process.
^{c}Dry out protocol = A resinated furnish is placed in a bag. Each resin is tested after holding resinated furnish in oven at either 140, 160 or 180 F. All panels are pressed for 250 seconds. The resinated furnish is placed in a bag to prevent loss of moisture too quickly while placed in oven. The bag is used because the bagged resinated furnish more accurately mimics the dry-out times seen on commercial apparatus.

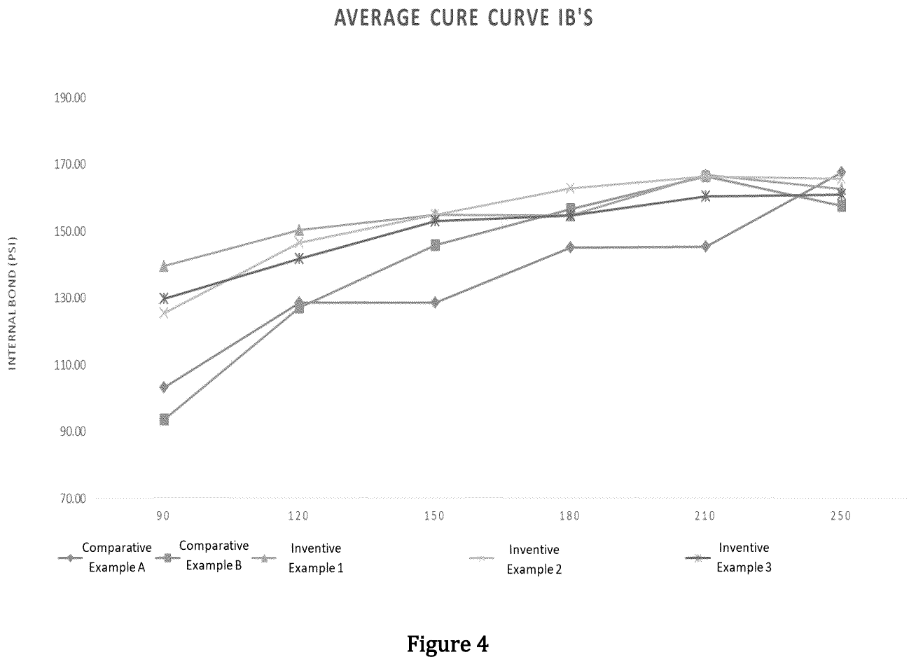

The particleboards are also tested for bonding cure speed and dry out/pre-cure resistance. To determine the Average Internal Bond according to ASTM-D1037, the panels are pressed for 250 seconds. FIG. 4 shows the Average Internal Bond (IB) Curve over time for cured Inventive Examples 1-3 and Comparative Examples A and B.

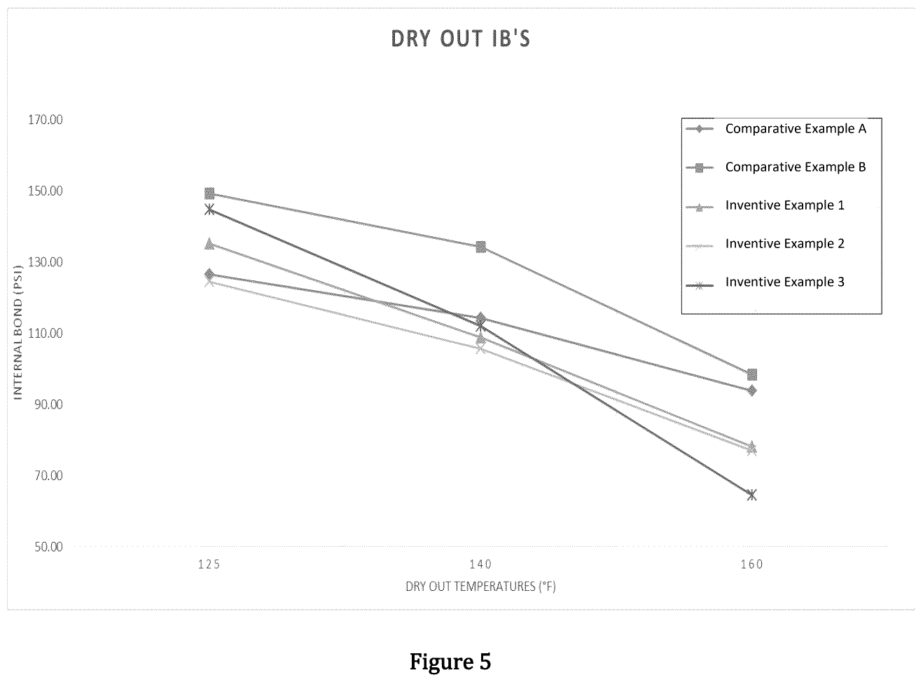

To evaluate the dry out/pre-cure AIB of the resins, the panels are placed in containers while increasing the temperature over a period of time from 125° F. to about 160° F. FIG. 5 shows the results from dry out/pre-cure Average Internal Bond of Inventive Examples 1-3 and Comparative Examples A and B.

Dry-out/pre-cure AlBs are lower than AlBs using standard panel process (without heating resinated furnish in oven) due to loss of efficiency (bonding potential) from the excess heat prior to pressing.

FIG. 4 indicates that resin compositions including lignosulfonate can actually improve the Internal Bond relative to Comparative Example A, which comprises melamine. Thus, Inventive Examples 1-3 provide resins capable of achieving suitable Internal Bond ranges much faster with the lignosulfonates.

Typically, resins that cure very quickly would correspondingly dry out at low temperatures. This is because the resin is exposed to elevated temperatures for a period of time before the apparatus is taken to curing temperatures. This pre-mature curing makes the resin lose strength after the curing step, and thus, resulting in dry out at lower temperatures. Based on this, it would be expected that Inventive Examples 1-3 would perform worse in the dry out step, since they experienced a fast cure. See FIG. 4. However, FIG. 5 indicates that Inventive Examples 1-3 have similar dry out rates when compared to Comparative Example A, comprising the melamine.

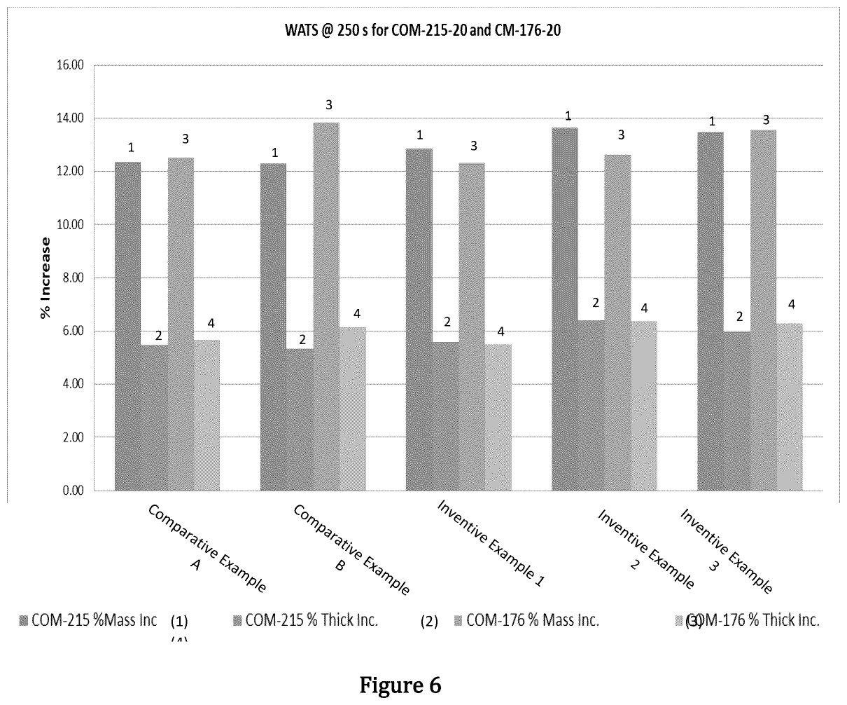

To determine the water-resistant properties, including water absorption and thickness swell, the boards were submerged into water for a period time in accordance with ASTM-D1037. The density (weight and thickness) was measured before and after submersion to determine the change. FIG. 6 shows the water tolerance and thickness swell (WATS) of cured Comparative Examples A and B and Inventive Examples 1-3.

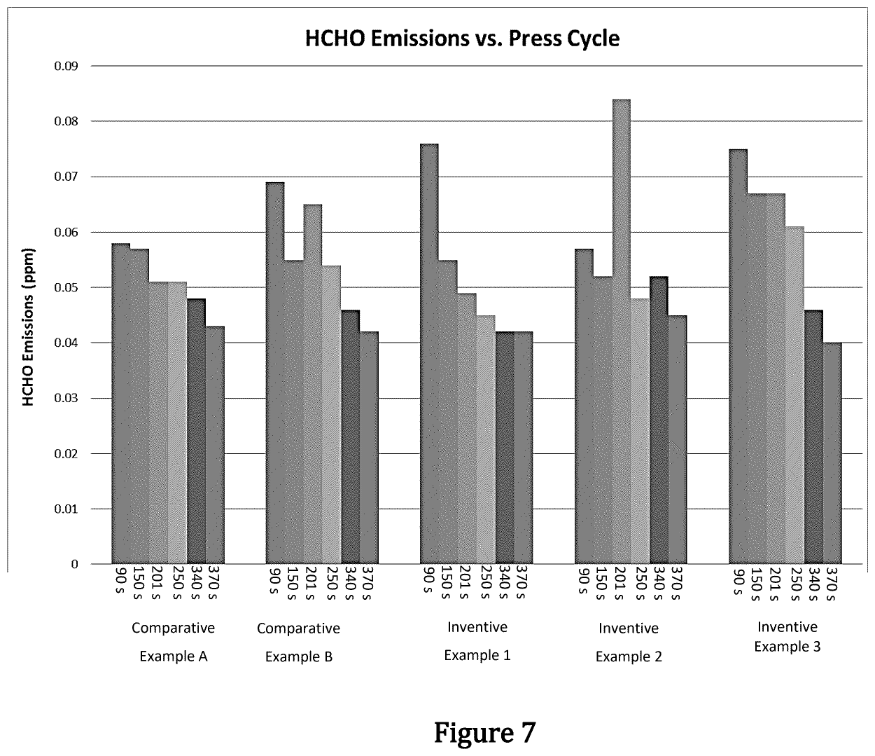

In addition to testing the boards for water resistance, the boards are tested for formaldehyde emissions. During the curing phase, the amount of formaldehyde volatilization is measured over time using ASTM-6007 and E1333. FIG. 7 shows the formaldehyde emissions vs. press cycle (90-370 seconds) for Comparative Examples A and B and Inventive Examples 1-3.

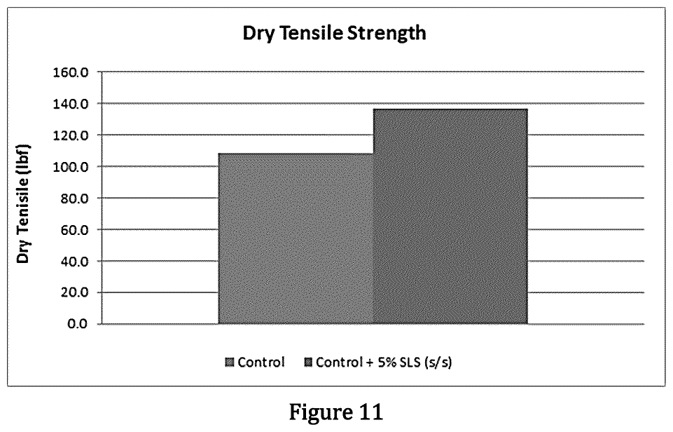

A glass fiber nonwoven was prepared by mixing glass fibers with the inventive resin system comprising 5 wt. % sodium lignosulfonate. A control sample (comparative example) was prepared by mixing the glass fibers with essentially the same resin system except without any lignosulfonate. The glass fiber was an Owens Corning product, OC 9501 having an average fiber length of 1.25 inches (3.175 cm). White water (a polyacrylamide) dispersant was used. The resin system containing the glass fibers was cured at 230° C. for 15 seconds to give an average basis weight of resin of 1.65 lbs/100 ft². The average loss on ignition was 20.3%. The dry tensile strength of the glass fiber nonwoven products were tested on a Thwing-Albert tensile tester (150 kg load cell) and the results are shown in FIG. 11. The dry tensile strength shows that the inventive glass fiber nonwoven had about 25-30% improvement in the dry tensile strength over the control (comparative) example.

It is possible, and sometimes preferred, to use components in a diluted form. This includes, but is not limited to urea, formaldehyde and melamine. All weight percents described herein, unless stated otherwise, are based on the weight of the component based on the total weight (liquids and solids) of the resin system. For instance, if 2 grams of a 50 wt. % aqueous solution of urea is added to the resin system to give a total weight of 10 grams, then the urea would be present in the resin system in an amount of 10 wt. %.

Other embodiments of the present disclosure will be apparent to those skilled in the art from consideration of the specification and practice of the embodiments disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

The foregoing embodiments are susceptible to considerable variation in practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

It is to be understood that each component, compound, substituent or parameter disclosed herein is to be interpreted as being disclosed for use alone or in combination with one or more of each and every other component, compound, substituent or parameter disclosed herein.

It is also to be understood that each amount/value or range of amounts/values for each component, compound, substituent or parameter disclosed herein is to be interpreted as also being disclosed in combination with each amount/value or range of amounts/values disclosed for any other component(s), compounds(s), substituent(s) or parameter(s) disclosed herein and that any combination of amounts/values or ranges of amounts/values for two or more component(s), compounds(s), substituent(s) or parameters disclosed herein are thus also disclosed in combination with each other for the purposes of this description.

It is further understood that each range disclosed herein is to be interpreted as a disclosure of each specific value within the disclosed range that has the same number of significant digits. Thus, a range of from 1-4 is to be interpreted as an express disclosure of the values 1, 2, 3 and 4.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

We claim:

1. A blended furnish, comprising:
a urea-formaldehyde (UF) resin or a melamine-urea-formaldehyde (MUF) resin;
a lignosulfonate, a kraft lignin or a sulfonated lignin;
a deep eutectic solvent;
an alkaline compound;
optionally an additive; and
a plurality of substrates,
wherein the blended furnish has a buffer capacity of 2-200 mL of 0.1 N HCl by the Acid Titration Value (ATV) Method using 20 grams of blended furnish for a period of time up to 20 days.

2. The blended furnish of claim 1, wherein the substrate is selected from the group consisting of lignocellulose substrates, natural fibers substrates, synthetic fibers substrates, glass fibers substrates and mixtures thereof.

3. The blended furnish of claim 1, wherein the lignosulfonate is selected from the group consisting of calcium lignosulfonate, magnesium lignosulfonate, potassium lignosulfonate, chrome lignosulfonate, ammonium lignosulfonate, sodium lignosulfonate and mixtures thereof.

4. The blended furnish of claim 1, wherein the lignosulfonate, the kraft lignin or the sulfonated lignin is blended with other additives selected from the group consisting of a raw lignin in powder or liquid form, a lignin added to additives combined with additional water, a urea water, a scavenger, a filler, an extender, a wax, a catalyst, a release agent, a buffering agent, a surfactant a cellulose or its derivative, and mixtures thereof.

5. The blended furnish of claim 1, wherein the lignosulfonate, the kraft lignin or the sulfonated lignin is in solid powder form, liquid form or combinations thereof.

6. The blended furnish of claim 1, wherein the alkaline compound comprises ammonia, an amine, a Group I metal hydroxide, a Group II metal hydroxide, Group I metal carbonate, a Group II metal carbonate, or combinations thereof.

7. The blended furnish of claim 1, wherein the additive is selected from the group consisting of catalyst, filler, buffer, base, tackifier, wax, water, scavenger, boron compound, phosphate, halogen compound, nitrogen compound, a cellulose or its derivative, and mixtures thereof.

8. The blended furnish of claim 1, wherein one or more additives are present.

9. The blended furnish of claim 1, wherein the pH of the blended furnish varies from about 3.0 to about 10.0.

10. The blended furnish of claim 1, wherein the blended furnish comprising the one or more lignosulfonate salt may have a distinct color that is noticeably different from the color of pure UF/MUF resins.

11. The blended furnish of claim 1, wherein the lignocellulose substrate comprises a granulated lignocellulose substrate, a flake lignocellulose substrate, a fibrous lignocellulose substrate or combinations thereof.

12. The blended furnish of claim 1, wherein the blended furnish comprises
about 0.0 wt. % to about 50 wt. % of the UF resin or the MUF resin;
about 0.1 wt. % to about 30 wt. % of the lignosulfonate, the kraft lignin or the sulfonated lignin;
about 0.1 wt. % to about 30 wt. % of the deep eutectic solvent;
about 0.0 wt. % to about 1 wt. % of the alkaline compound; and
about 0.0 wt. % to about 40 wt. % of the additive,
wherein each weight percent is based on the total weight of the blended furnish.

13. The blended furnish of claim 1, wherein the sulfonated lignin is selected from the group consisting of lignosulfonates: sodium lignosulfonate, calcium lignosulfonate, magnesium lignosulfonate, ammonium lignosulfonate; sulfite lignins; kraft lignins: hardwood: poplar, elm, birch, beech, maple, eucalyptus; softwood: spruces, pinces, firs, hemlocks, cedars, tamarack; agricultural: wheat straw, corn stover, switchgrass, kenaf, bamboo; soda lignins: hardwood: poplar, elm, birch, beech, maple, eucalyptus; softwood: spruces, pinces, firs, hemlocks, cedars, tamarack; agricultural: wheat straw, corn stover, switchgrass, kenaf, bamboo and mixtures thereof.

14. The blended furnish of claim 13, wherein the lignosulfonate or the sulfonated lignin is a modified lignosulfonate or a modified sulfonated lignin.

15. The blended furnish of claim 1, wherein the deep eutectic solvent is selected from the group consisting of metal salt+organic salt, metal salt hydrate+organic salt, organic salt+hydrogen bond donor, metal salt hydrate+hydrogen bond donor, 1-butylimidazolium chloride:copper chloride:zinc chloride, 1-butyl-1-methylpyrrodlidinium bromide:choline chloride:glycerol, 1-butyl-3-methylimidazolium chloride:zinc chloride, 1-butyl-3-methylimidazolium chloride:zinc chloride:acetamide, 1-butyl-3-methylimidazolium chloride:zinc chloride:dimethylurea, 1-butyl-3-methylimidazolum bromide:Urea:zinc bromide, 1-butyl-3-methylimidazolum bromide:zinc bromide:acetamide, 1-butyl-3-methylimidazolum bromide:zinc bromide:dimethylurea, 1-butyl-3-methylimidazolum chloride:glycerol:zinc bromide, 1-butyl-3-methylimidazolum chloride:lithium chloride, 1-butyl-3-methylimidazolum chloride:zinc bromide:acetamide, 1-butyl-3-methylimidazolum chloride:zinc chloride, 1-butyl-3-methylimidazolum chloride:zinc chloride:acetamide, 1-butyl-3-methylimidazolum chloride:zinc chloride:urea, 1-ethyl-3-butylbenzotriazolium hexafluorophosphate:imidazole, 1-ethyl-3-methyl imidazolium chloride:diethylenetriamine:ethylene Glycol, 1-ethyl-3-methyl imidazolium chloride:diethylenetriamine:diethylene Glycol, 2-(acetyloxy)-N,N,N-trimethylethanaminium chloride urea, 2-acetyloxy-N,N,N-trimethylethanaminium chloride:tin(II) chloride, 2-acetyloxy-N,N,N-trimethylethanaminium chloride:zinc bromide, 2-chloro-N,N,N-trimethylethanaminium chloride:urea, 2-fluoro-N,N,N-trimethylethanaminium bromide:urea, 4-amino-1,2,4-triazole:glycerol:resorcinol, acetamide:diethylenetriamine:diethylene glycol, acetamide:diethylenetriamine:ethylene glycol, acetamide urea:glycerol, acetamide:urea:sorbitol, acetamide:zinc chloride, allyltriphenylphosphonium bromide:diethylene glycol, aluminum ammonium sulfate:urea, aluminum chloride:acetamide, aluminum chloride:urea, aluminum nitrate:urea, ammonium chloride:melamine:lactic acid, benzyltriethylammonium chloride:toluenesulfonic acid, benzyltrimethylammonium chloride:toluenesulfonic acid, benzyltriphenylphosphonium chloride:ethylene glycol, benzyltriphenylphosphonium chloride diethylene glycol, benzyltriphenylphosphonium chloride:glycerol, betaine:1,2-propanediol:lactic acid, betaine:1,3-propanediol:lactic acid, betaine:ethylene glycol:glycerol, betaine:diethylene glycol:glycerol, betaine:ethylene glycol:lactic acid, betaine:dietheylene glycol:lactic acid, betaine:glycerol:citric acid, betaine:citric acid, betaine:sucrose, betaine:sucrose:proline, betaine:urea:glycerol, choline acetate:ethylene glycol, choline acetate:diethylene glycol, choline acetate:glycerol, choline acetate:urea, choline chloride:1,2,4-triazole:ethylene glycol, choline chloride:1,2,4-triazole:diethylene glycol, choline chloride:1,4-butanediol, choline chloride:1-methylurea, choline chloride:2,2,2-trifluroacetamide, choline chloride:acetamide, choline chloride:acetamide:lactic acid, choline chloride:acetic acid, choline chloride:cromium(III) chloride, choline chloride:ethylene glycol, choline chloride:ethylene glycol:lactic acid, choline chloride:ethylene glycol:urea, choline chloride:diethylene glycol, choline chloride:diethylene glycol:lactic acid, choline chloride:diethylene glycol:urea, choline chloride:fructose, choline chloride:glucose, choline chloride:glucose, choline chloride:glucose, choline chloride:glucose:glycerol, choline chloride:glutaric acid, choline chloride:glycerol, choline chloride:glycine, choline chloride:glycolic acid, choline chloride:imidazole, choline chloride:imidazole:ethylene glycol, choline chloride:imidazole:diethylene glycol, choline chloride:itaconic acid, choline chloride:L-(+)-tartaric acid, choline chloride:lactic acid, choline chloride:lactic acid:urea, choline chloride:lactose, choline chloride:levulinic acid, choline chloride:magnesium Chloride, choline chloride:malonic acid, choline chloride:malonic Acid:1,2-propanediol, choline chloride:malonic Acid:1,3-propanediol, choline chloride:maltose, choline chloride:mannitol, choline chloride:o-cresol, choline chloride:oxalic Acid, choline chloride:oxalic Acid:1,2-propanediol, choline chloride:phenol, choline chloride:phenol:diethylene glycol, choline chloride:phenol:ethylene glycol, choline chloride:phenylacetic acid, choline chloride:phenylpropionic acid, choline chloride:propionic acid, choline chloride:raffinose, choline chloride:resorcinol, choline chloride:sorbitol, choline chloride:sorbitol, choline chloride:sorbitol, choline chloride:sorbitol, choline chloride:sorbitol:glycerol, choline chloride:sucrose, choline chloride:tetrazole:diethylene glycol, choline chloride:tetrazole:ethylene glycol, choline chloride:tin(II) chloride, choline chloride:toluenesulfonic acid, choline chloride:triethylene glycol, choline chloride:urea, choline chloride:arginine, choline chloride:urea:glycerol, choline chloride:urea:lactic acid, choline chloride:xylenol, choline chloride:xylitol, choline chloride:xylitol:glycerol, choline chloride:xylose, choline chloride:zinc bromide, choline chloride:zinc chloride, choline chloride:zinc nitrate, choline chloride:1,4-butanediol, choline fluoride:urea, choline nitrate:urea, citric acid:adonitol, citric acid:alanine, citric acid:alanine:lactic acid, citric acid:choline chloride, citric acid:dimethylurea, citric acid:maltose, citric acid:proline, citric acid:proline:glycerol, citric acid:proline:lactic acid, citric acid:raffinose, citric acid:ribitol, citric acid:sorbose, citric acid:sucrose, citric Acid:xylitol, diethylethanolammonium chloride:copper chloride:diethylene glycol, diethylethanolammonium chloride:copper chloride:ethylene glycol, ethylammonium chloride:1-(trifluoromethyl) urea, ethylammonium chloride:methylurea, ethylammonium chloride:urea, ethylammonium chloride:Zinc chloride:glycerol, ethylene glycol:iron(III) chloride, ethylene glycol:tin(II) chloride, ethylene glycol:zinc chloride, diethylene glycol:iron(III) chloride, diethylene glycol:tin(II) chloride, diethylene glycol:zinc chloride, fructose:glutamine:zinc chloride, fructose:urea:sodium chloride, fructose:glycine:zinc chloride, glucose:dimethylurea:ammonium chloride, glucose:glutamine:zinc chloride, glucose:glycine:zinc chloride, glucose:urea, glucose:urea:ammonium chloride, glucose:citric acid, glucose:malic acid, lactic acid:alanine, lactic acid:betaine, lactic acid:glycine, lactic acid:histidine, lactic acid:proline, lactose:dimethylurea:ammonium chloride, malic acid:alanine, malic acid:Alanine:Lactic acid, malic acid:betaine, malic acid:choline chloride, malic acid:choline chloride:glycerol, malic acid:glycine, malic acid:histidine, malic acid:nicotinic acid, malic acid:proline, malic acid:proline:lactic acid, maltose:dimethylurea:sodium chloride, maltose:dimethylurea:sodium chloride, mannose:dimethylurea, menthol:camphor, methyltriphenylphosphonium bromide:ethylene glycol, methyltriphenylphosphonium bromide:diethylene glycol, methyltriphenylphosphonium bromide glycerol, methyltriphenylphosphonium bromide:glycerol:diethylene glycol, methyltriphenylphosphonium bromide:glycerol:ethylene glycol, methyltriphenylphosphonium bromide:triethylene glycol, methyltriphenylphosphonium bromide 2,2,2-trifluoroacetamide, N-(2-hydroxyethyl)-N,N-dimethylanilinium chloride:Iron(III) Chloride, N-(2-hydroxyethyl)-N,N-dimethylanilinium chloride:Tin(II) Chloride, N,N,N-trimethyl(phenyl)methanaminium chloride:urea, N,N-diethylethanolammonium chloride:ethylene glycol, N,N-diethylethanolammonium chloride:diethylene glycol, N,N-diethylethanolammonium chloride:glycerol, N,N-diethylethanolammonium chloride:triethylene glycol, N-benzyl-2-hydroxy-N-(2-hydroxyethyl)-N-methylethanaminium chloride:urea, N-benzyl-2-hydroxy-N,N-dimethylethanaminium chloride:urea, N-ethyl-2-hydroxy-N,N-dimethylethanaminium chloride:urea, N,N,N-trimethyl(phenyl)methanaminium chloride:urea, oxalic acid anhydrous:alanine, oxalic acid anhydrous:bentaine, oxalic acid anhydrous:benzyltrimethylammonium chloride, oxalic acid anhydrous:choline chloride, oxalic acid anhydrous:choline chloride:ethylene glycol, oxalic acid anhydrous:choline chloride:diethylene glycol, oxalic acid anhydrous:choline chloride:glycerol, oxalic acid anhydrous:proline, oxalic acid dihydrate:alanine, oxalic acid dihydrate:betaine, oxalic acid dihydrate:choline chloride, oxalic acid dihydrate:glycine, oxalic acid dihydrate:histidine, oxalic acid dihydrate:nicotinic acid, oxalic acid dihydrate:proline, phosphocholine chloride:dichloroacetic acid:lauric acid, potassium carbonate:ethylene glycol, potassium carbonate:diethylene glycol, potassium carbonate:glycerol, saccarose:Urea:calcium chloride, sorbitol:dimethylurea:ammonium chloride, sorbitol:urea:ammonium chloride, tetrabutylammonium bromide:imidazole, tetrabutylammonium bromide:lauric Acid:capric Acid, tetrabutylammonium bromide:oleic Acid:capric Acid, tetrabutylammonium chloride:ethylene glycol, tetrabutylammonium chloride:diethylene glycol, tetrabutylammonium chloride:glycerol, tetrabutylammonium chloride:toluenesulfonic acid, tetrabutylammonium chloride:triethylene glycol, tetrabutylammonium bromide:octanoic acid:thymol, tetrabutylphopsphonium chloride:toluenesulfonic acid, tetrapropylammonium bromide:ethylene glycol, tetrapropylammonium bromide:diethylene glycol, tetrapropylammonium bromide:glycol, tetrapropylammonium bromide:triethylene glycol, trimethylglycine:glycerin, trimethylglycine:glycolic acid, trimethylglycine:urea, urea:calcium chloride, urea:cromium(III) chloride, urea:iron(III) chloride, urea:tin(II) chloride, urea:zinc chloride and mixtures thereof.

16. A method for preparing a blended furnish, comprising:
adding a plurality of substrates;
mixing a urea-formaldehyde (UF) resin or a melamine-urea-formaldehyde (MUF) resin optionally with an amine and water at a pH of 5-11, preferably 6-10;
optionally adding one or more additives;
adding a lignosulfonate salt, a kraft lignin or a sulfonated lignin and a deep eutectic solvent;
optionally adding one or more additives to form the blended furnish,
wherein the blended furnish has a buffer capacity of 2-200 mL of 0.1 N HCl by the Acid Titration Value (ATV) Method using 20 grams of blended furnish for a period of time up to 20 days.

17. A method for preparing a blended furnish, comprising:
adding a plurality of substrates;
mixing a urea-formaldehyde (UF) resin or a melamine-urea-formaldehyde (MUF) resin, a lignosulfonate salt, a kraft lignin or a sulfonated lignin and a deep eutectic solvent, optionally with an amine and water at a pH of 5-11, preferably 6-10;
optionally adding one or more additives to form the blended furnish,
wherein the blended furnish has a buffer capacity of 2-200 mL of 0.1 N HCl by the Acid Titration Value (ATV) Method using 20 grams of blended furnish for a period of time up to 20 days.

18. A method for preparing a blended furnish, comprising:
adding a plurality of substrates;
mixing a lignosulfonate salt, a kraft lignin or a sulfonated lignin and a deep eutectic solvent with the substrates;
adding a urea-formaldehyde (UF) resin or a melamine-urea-formaldehyde (MUF) resin optionally with an amine and water at a pH of 5-11, preferably 6-10;
optionally adding one or more additives to form the blended furnish,
wherein the blended furnish has a buffer capacity of 2-200 mL of 0.1 N HCl by the Acid Titration Value (ATV) Method using 20 grams of blended furnish for a period of time up to 20 days.

19. A composite product, comprising:
a plurality of substrates; and
at least partially cured blended furnish of claim 1.

20. The composite product of claim 19, wherein the composite product comprises plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.
